(19) United States
(12) Patent Application Publication
(10) Pub. No.: US 2025/0362577 A1
(43) Pub. Date: Nov. 27, 2025

(54) LASER PROJECTION DEVICE

(71) Applicant: HISENSE LASER DISPLAY CO., LTD., Qingdao (CN)

(72) Inventors: Yaqian Li, Qingdao (CN); Ke Yan, Qingdao (CN); Wei Li, Qingdao (CN); Youliang Tian, Qingdao (CN); Yuanhao Qiu, Qingdao (CN); Yao Li, Qingdao (CN); Zhe Xing, Qingdao (CN); Lei Cui, Qingdao (CN)

(21) Appl. No.: 19/292,788

(22) Filed: Aug. 6, 2025

Related U.S. Application Data
(63) Continuation of application No. PCT/CN2024/078678, filed on Feb. 27, 2024.

(30) Foreign Application Priority Data
Feb. 27, 2023 (CN) 202310173172.8
Feb. 27, 2023 (CN) 202310178493.7
Feb. 27, 2023 (CN) 202320342771.3

(51) Int. Cl. G03B 21/20; G03B 21/16

(52) U.S. Cl. CPC G03B 21/208; G03B 21/16; G03B 21/2033; G03B 21/2066; G03B 21/2073

(57) ABSTRACT

The present disclosure provides a laser projection device, including a light source system, an optical engine system, a projection lens, and a heat dissipation device; wherein the light source system is adjacent to and connected to the heat dissipation device, the light source system is configured to provide a laser beam to the optical engine system, and the heat dissipation device is configured to dissipate heat from the light source system; and the optical engine system and the projection lens are disposed on one side of the light source system and stacked along a first direction, the optical engine system is configured to modulate the laser beam provided by the light source system into an image beam and then emit the image beam to the projection lens, and the projection lens is configured to image the image beam to an image and then emit the image to a projection screen.

This application is a continuation application of PCT application No. PCT/CN2024/078678 filed on Feb. 27, 2024, which claims priority to Chinese Patent Application No. 202310178493.7 filed on Feb. 27, 2023, and entitled “METHOD FOR ADJUSTING LIGHT SOURCE SYSTEM”, Chinese Patent Application No. 202310173172.8 filed on Feb. 27, 2023, and entitled “LASER PROJECTION DEVICE”, Chinese Patent Application No. 202320342771.3 filed on Feb. 27, 2023, and entitled “LIGHT SOURCE SYSTEM AND LASER PROJECTION DEVICE”, the contents of which are herein incorporated by reference in their entireties.

### TECHNICAL FIELD

The present disclosure relates to the field of optoelectronic technologies, and in particular, relates to a light source system and a laser projection device.

### BACKGROUND

With the continuous development of technology, laser projection devices are increasingly applied to consumers' work and life. At present, a laser projection device mainly includes a light source system, an optical engine system, and a lens.

However, laser beams provided by the current light source system are prone to color deviation, resulting in poor display effects of the projection images.

### SUMMARY

In one aspect, the present disclosure provides a light source system for assembly in a laser projection device. The light source system includes:
a housing, a laser device and an end cover connected to the housing, and an adjustment assembly and a plurality of lenses disposed in the housing;
wherein the housing is provided with a light-transmitting hole and an assembly opening arranged oppositely, the laser device is connected to the housing at the light-transmitting hole, the end cover is detachably connected to the housing at the assembly opening, and at least one of the plurality of lenses is connected to the housing through the adjustment assembly; and
the light source system is configured such that after the end cover is removed from the housing, the adjustment assembly in the housing is exposed through the assembly opening, and the posture and/or position of the at least one lens is capable of being adjusted through the adjustment assembly.

In another aspect, the present disclosure provides a laser projection device including the light source system described in the present disclosure.

### BRIEF DESCRIPTION OF THE DRAWINGS

FIG. 1 is a partial schematic diagram of a light source system according to some embodiments of the present disclosure;

FIG. 2 is a structural schematic diagram of a light source system according to some embodiments of the present disclosure;

FIG. 3 is a structural schematic diagram of a laser device according to some embodiments of the present disclosure;

FIG. 4 is a schematic diagram showing a cooperation between a lens and a laser device according to some embodiments of the present disclosure;

FIG. 5 is a structural schematic diagram of another light source system according to some embodiments of the present disclosure;

FIG. 6 is a structural schematic diagram of an adjustment assembly according to some embodiments of the present disclosure;

FIG. 7 is a structural schematic diagram of a bracket according to some embodiments of the present disclosure;

FIG. 8 is a schematic diagram showing a connection relationship between a bracket and a lens according to some embodiments of the present disclosure;

FIG. 9 is a structural schematic diagram of another light source system according to some embodiments of the present disclosure;

FIG. 10 is a structural schematic diagram of yet another light source system according to some embodiments of the present disclosure;

FIG. 11 is a schematic diagram showing a positional relationship between a first laser device and a second laser device according to some embodiments of the present disclosure;

FIG. 12 is a schematic diagram showing a positional relationship between another first laser device and a second laser device according to some embodiments of the present disclosure;

FIG. 13 is a schematic diagram showing a cooperation between a laser device and a lens according to some embodiments of the present disclosure;

FIG. 14 is a schematic diagram showing a connection relationship between a housing and an end cover according to some embodiments of the present disclosure;

FIG. 15 is a schematic diagram showing a connection relationship between a housing and a laser device according to some embodiments of the present disclosure;

FIG. 16 is a structural schematic diagram of still another light source system according to some embodiments of the present disclosure;

FIG. 17 is a structural schematic diagram of yet another laser according to some embodiments of the present disclosure;

FIG. 18 is a schematic diagram showing a cooperation between a polarization conversion component and a laser device according to some embodiments of the present disclosure;

FIG. 19 is a structural schematic diagram of yet another light source assembly according to some embodiments of the present disclosure;

FIG. 20 is a structural schematic diagram of still another light source assembly according to some embodiments of the present disclosure;

FIG. 21 is a structural schematic diagram of still another light source assembly according to some embodiments of the present disclosure;

FIG. 22 is a spot schematic of laser beams emitted by a light source system according to some embodiments of the present disclosure;

FIG. 23 is a structural schematic diagram of still another light source assembly according to some embodiments of the present disclosure;

FIG. 24 is a structural schematic diagram of a prism according to some embodiments of the present disclosure;

FIG. 25 is a schematic diagram showing a cooperation between a prism and a light-emitting unit according to some embodiments of the present disclosure;

FIG. 26 is a schematic diagram showing a cooperation between another prism and a light-emitting unit according to some embodiments of the present disclosure;

FIG. 27 is a structural schematic diagram of another prism according to some embodiments of the present disclosure;

FIG. 28 is a partial schematic diagram of still another light source system according to some embodiments of the present disclosure;

FIG. 29 is an optical path schematic diagram of a light source system according to some embodiments of the present disclosure;

FIG. 30 is an optical path schematic diagram of another light source system according to some embodiments of the present disclosure;

FIG. 31 is an optical path schematic diagram of yet another light source system according to some embodiments of the present disclosure;

FIG. 32 is a structural schematic diagram of a laser projection device according to some embodiments of the present disclosure;

FIG. 33 is a structural schematic diagram of another laser projection device according to some embodiments of the present disclosure;

FIG. 34 is a structural schematic diagram of a heat dissipation device according to some embodiments of the present disclosure;

FIG. 35 is a structural schematic diagram of yet another laser projection device according to some embodiments of the present disclosure;

FIG. 36 is a structural block diagram of a laser projection device according to some embodiments of the present disclosure;

FIG. 37 is a structural schematic diagram of a heat dissipation component according to some embodiments of the present disclosure;

FIG. 38 is a structural schematic diagram of a heat dissipation component according to some embodiments of the present disclosure;

FIG. 39 is a schematic diagram showing a connection relationship between a light source assembly and a heat conducting plate according to some embodiments of the present disclosure;

FIG. 40 is a flowchart of a method for adjusting a light source system according to some embodiments of the present disclosure;

FIG. 41 is a flowchart of another method for adjusting a light source system according to some embodiments of the present disclosure;

FIG. 42 is a schematic diagram showing a deviation between a color of a portion of a target image and a specified color according to some embodiments of the present disclosure; and

FIG. 43 is a schematic diagram showing a deviation between a color of a portion of another target image and a specified color according to some embodiments of the present disclosure.

### DETAILED DESCRIPTION

To make the objectives, technical solutions, and advantages of the present disclosure clearer, embodiments of the present disclosure will be described in further detail below in conjunction with the accompanying drawings.

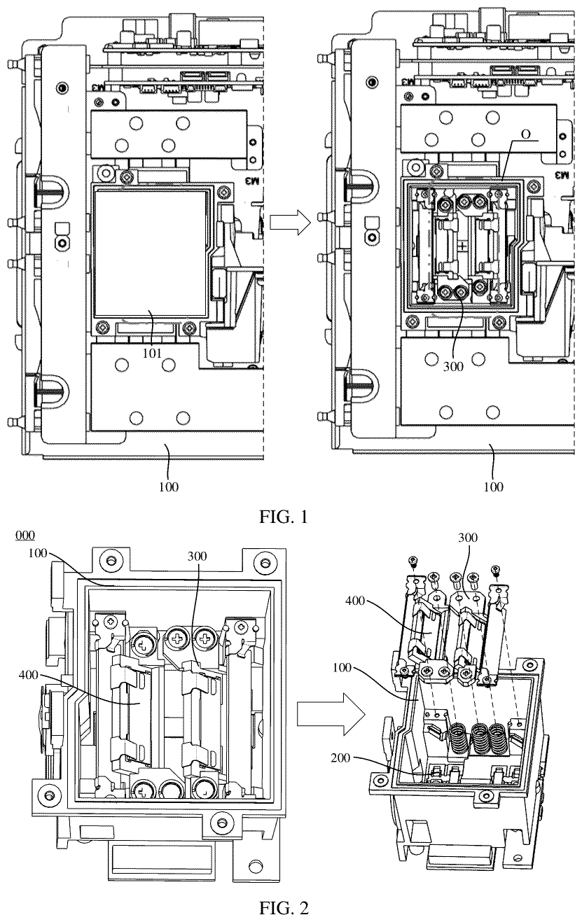

On the one hand, referring to FIGS. 1 and 2, in some embodiments, a light source system 000 may be assembled in a laser projection device, and the light source system 000 may include: a housing 100, a laser device 200 and an end cover 101 connected to the housing 100, and an adjustment assembly 300 and a plurality of lenses 400 disposed in the housing 100. Here, at least one of the plurality of lenses 400 in the light source system 000 may be connected to the housing 100 of the light source system 000 through the adjustment assembly 300. The light source system 000 is configured such that after the end cover 101 is removed from the housing 100, the adjustment assembly 300 in the housing 100 is exposed through an assembly opening O, and the posture and/or position of at least one lens 400 is capable of being adjusted through the adjustment assembly 300. The laser device 200 in the light source system 000 can be used to emit the laser beam required for a laser projection device to project an image.

The plurality of lenses 400 in the light source system 000 may face the light-output side of the laser device 200. The lenses 400 may be used to direct the laser beam emitted by the laser device 200 to relevant optical devices in the laser projection device for processing. After processing the laser beam, the relevant optical devices may direct the processed laser beam to the projection lens in the laser projection device. The projection lens may project the processed laser beam to obtain a projection image. It can be seen that whether the light beam emitted by the laser device 200 can be accurately directed to the relevant optical devices by the lenses 400 is a key factor for the projection lens to project a projection image with a good display effect.

During the factory inspection of the laser projection device, when there is a deviation between the color of a certain region in the projection image projected by the projection lens and the specified color, it is necessary to adjust the posture of the lens 400. In the related art, the posture of the lens 400 is often adjusted through an adjustment mechanism arranged outside the housing 100. However, due to the limited space between the light source system 000 and other components in the laser projection device, it is relatively difficult for operators to adjust the lens 400 from the outside of the housing 100. Moreover, since the actual posture of the lens 400 cannot be observed, such an adjustment method is not conducive to operators summing up experience in adjusting the lens 400, resulting in low efficiency of operators in adjusting the lens 400. This, in turn, leads to a longer time spent in the factory inspection and adjustment process of the laser projection device, and further results in low factory efficiency of the laser projection device.

In the present disclosure, the housing 100 in the light source system 000 may be provided with a light-transmitting hole T and an assembly opening O. The laser device 200 may be connected to the housing 100 at the light-transmitting hole of the housing 100, and the end cover 101 may be detachably connected to the housing 100 at the assembly opening O of the housing 100. Here, the adjustment assembly 300 may be disposed inside the housing 100.

In some embodiments, during the inspection of the laser projection device, when the operator needs to adjust the position of the lens 400, the operator can directly remove the end cover 101 from the housing 100 and use the adjustment assembly 300 in the housing 100 to adjust the posture of the lens 400 in the light source system 000. There is no need to disassemble the light source system 000 from the laser projection device before adjusting the lens 400 in the light source system 000. In this way, the efficiency of adjusting the posture of the lens 400 can be further improved, which in turn can further improve the adjustment efficiency of the light source system, thereby increasing the factory efficiency of the laser projection device.

In some embodiments, during the factory inspection of the laser projection device, when it is necessary to inspect the light source system 000, the operator can also inspect the components in the light source system 000 by removing the end cover 101 from the housing 100, without disassembling the light source system 000, thereby improving the efficiency of the operator's inspection of the light source system 000. In addition, after inspecting the light source system 000, if any components in the light source system 000 are found to be damaged, the damaged component in the light source system 000 can be replaced through the assembly opening O of the housing 100 without disassembling the light source system 000, thereby improving the efficiency of factory inspection and maintenance of laser projection device.

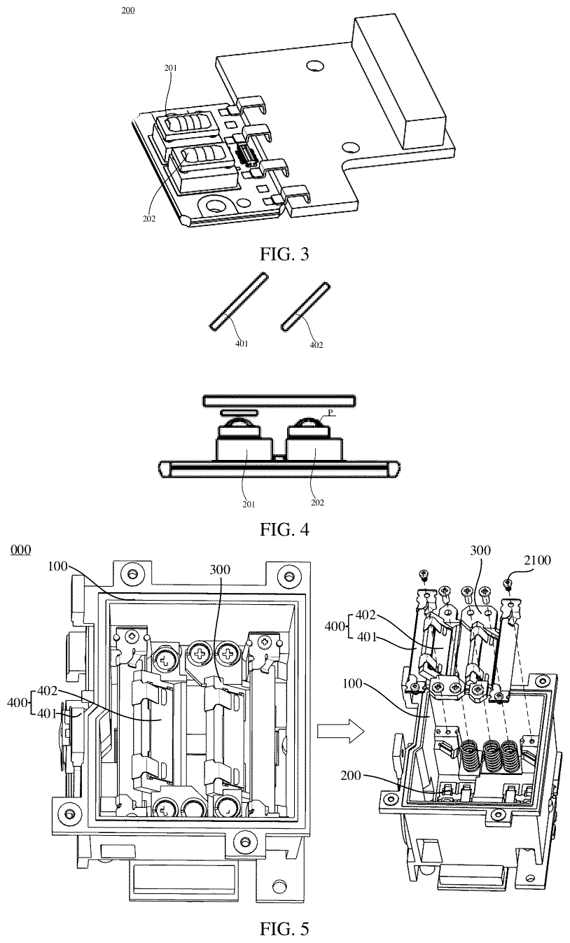

To provide a clearer view of the structure of the laser device 200 in the light source system 000, referring to FIG. 3, in some embodiments, the laser device 200 in the light source system 000 may include: a row of first laser units 201 for emitting green laser beam and blue laser beam, and a row of second laser units 202 for emitting red laser beam. One laser device 200 may have multiple rows of light-emitting units, with each row including: at least one row of first laser units 201 for emitting green laser beams and blue laser beams, and at least one row of second laser units 202 for emitting red laser beams. Here, part of the first laser units 201 in one row are laser units for emitting the green laser beam, and the other part are laser units for emitting the blue laser beam. Each second laser unit 202 in one row of second laser units 202 is a laser unit for emitting a red laser beam. It should be noted that the present disclosure is illustrated using an example where the laser device 200 has two rows of laser units, and the number of laser units in the laser device 200 is not limited.

To provide a clearer view of the cooperation mode between the plurality of lenses 400 and the laser device 200, referring to FIG. 4, the plurality of lenses 400 in the light source system 000 may include: a first lens 401 disposed on the light-output side of the row of the first laser units 201, and a second lens 402 disposed on the light-output side of the row of the second laser units. To provide a clearer view of the cooperation mode between the lens 400 and the laser device 200, referring to FIG. 5, the first lens 401 may be connected to the housing 100 in the light source system 000 through the adjustment assembly 300.

The light source system 000 is configured such that the adjustment assembly 300 can control the rotation of the first lens 401 around an axis parallel to the length direction of the first lens 401, and the adjustment assembly 300 can control the rotation of the first lens 401 around an axis perpendicular to the length direction of the first lens 401. Thus, the operator can assemble the first lens 401 in the housing 100 using the adjustment assembly 300 and adjust the posture of the first lens 401 through the adjustment assembly 300. It should be noted that the light source system 000 may further include a fastening component 2100 for securing the second lens 402 inside the housing 100. In this way, the operator can use the fastening component 2100 to secure the second lens 402 inside the housing 100.

In the present disclosure, when the operator observes a deviation between the color of a certain region in the target image projected by the laser projection device and the specified color, that is, when the target image projected by the laser projection device has a color cast problem, it is only necessary to adjust the posture of the first lens 401 corresponding to the first laser unit 201 among the plurality of lenses 400 to adjust the color of a certain region in the target image. This reduces the number of lenses 400 that need to be adjusted, thereby improving the efficiency of adjusting the lenses 400. Since the operator can secure the second lens 402 inside the housing 100 through the fastening component 2100, during the process where the operator adjusts the posture of the first lens 401 through the adjustment assembly 300, the posture of the second lens 402 will not change due to interference from the external environment, which can prevent interference from the external environment from affecting the adjustment result of the target image.

It should be noted that the color of the target image projected by the laser projection device is formed by the mixture of blue laser beam, green laser beam, and red laser beam. Due to the large divergence angle of the red laser beam, the spot size of the red laser beam is larger than that of the blue laser beam and the green laser beam. Therefore, when a color cast occurs in the target image of the laser projection device, to ensure the adjustment efficiency of the light source system, only the positions of the blue laser beam and green laser beam corresponding to the target image need to be adjusted, such that the positions of the blue laser spot and green laser spot can correspond to the position of the red laser spot. When the operator observes that a color cast occurs in a certain region of the target image projected by the laser projection device, since a row of first laser units 201 can emit blue laser beam and green laser beam, the operator can adjust the posture of the first lens 401 on the light-output side of the row of first laser units 201 to adjust the corresponding positions of the blue laser beam and green laser beam in the target image, such that the color of the target image is consistent with the specified color. In this way, the operator only needs to adjust the posture of the first lens 401 to solve the color cast problem in the target image.

In some embodiments, referring to FIG. 6, the adjustment assembly 300 may include: a bracket 301 for supporting the first lens 401, and a plurality of adjustment members 302 connected to the bracket 301, each of which can be secured inside the housing 100 after passing through the bracket 301. Thus, the operator can more conveniently adjust the posture of the first lens 401 using the adjustment members 302. At least one adjustment member 302 in the adjustment assembly 300 can move along a first target direction X1 to adjust the posture of the first lens 401 supported by the bracket 301 in the adjustment assembly 300. The first target direction X1 is parallel to the light emission direction of the laser device 200.

In some embodiments, when it is necessary to adjust the posture of the first lens 401, the operator can control some adjustment members 302 in the adjustment assembly 300 to move along the first target direction X1, thereby causing the adjustment members 302 to drive one or more sides of the bracket 301 in the adjustment assembly 300 to move along the first target direction X1, changing the posture of the bracket 301, and thus causing the posture of the first lens 401 to correspondingly change. Thus, the operator can adjust the posture of the first lens 401 by controlling the movement of the adjustment members 302.

In some embodiments, as shown in FIG. 6, each adjustment member 302 may include: a support post 302a, an elastic element 302b, and an adjusting screw 302c. The support post 302a in the adjustment member 302 may be secured inside the housing 100 of the light source system 000, and the height direction of the support post 302a may be parallel to the first target direction X1. The end face of the support post 302a may have a threaded hole, and the adjusting screw 302c in the adjustment member 302 is used to pass through the bracket 301 and threadedly connect with the threaded hole. The elastic element 302b may be mounted on the support post 302a, and the two ends of the elastic element 302b may respectively abut against the bracket 301 and the interior of the housing 100. By controlling the screwing depth of the adjusting screw 302c in the threaded hole, the movement of the adjusting screw 302c along the first target direction X1 can be controlled.

During the installation of the light source system 000, the operator can secure the bracket 301 to the end face of the support post 302a through the adjusting screw 302c using a threaded engagement method. In this case, the adjusting screw 302c applies a clamping force to the bracket 301, causing the bracket 301 to apply a clamping force to the elastic element 302b, thereby compressing the elastic element 302b and storing elastic force. Thus, when it is necessary to adjust the posture of the first lens 401, the operator can control the adjusting screw 302c in the adjustment assembly 300 to move along the first target direction X1, causing the elastic element 302b to release elastic force and apply a thrust along the first target direction X1 to the bracket 301, thereby changing the posture of the bracket 301.

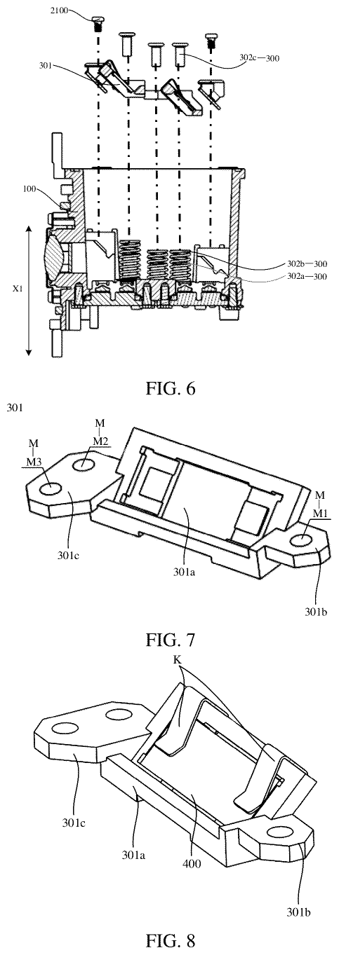

In some embodiments, referring to FIG. 7, the bracket 301 may include: a carrier 301a, a first connector 301b, and a second connector 301c. The carrier 301a in the bracket 301 can be used to carry the first lens 401. Thus, when the posture of the bracket 301 changes, since the first lens 401 can be positioned on the carrier 301a in the bracket 301, the posture of the first lens 401 can correspondingly change with the change in the posture of the bracket 301. For example, as shown in FIG. 8, the operator can secure the lens 400 to the carrier 301a of the bracket 301 using a plurality of fixing springs K. In this way, it can be ensured that the posture of the first lens 401 changes correspondingly with the change in the posture of the bracket 301.

The first connector 301b and the second connector 301c in the bracket 301 are disposed on both sides of the carrier 301a along the length direction of the lens 400. The first connector 301b may be provided with at least one connection hole M, and the second connector 301c may be provided with at least two connection holes M. In each adjustment assembly 300, the plurality of connection holes M in the bracket 301 may be in one-to-one correspondence with the plurality of adjusting screws 302c, and each adjusting screw 302c may be used to pass through the corresponding connection hole M and threadedly connect with the corresponding threaded hole. Thus, the operator may control the adjusting screws 302c at different positions to move toward the first target direction X1, thereby causing the bracket 301 to change its posture in different ways. In this way, the operator can more precisely control the changes in the posture of the bracket 301, enabling the operator to adjust the corresponding adjusting screws 302c based on the specific circumstances of the color cast problem in the target image projected by the laser projection device, thereby more efficiently adjusting the posture of the lens 400.

In some embodiments, as shown in FIGS. 7, 9, and 10, the first connector 301b and the second connector 301c may be fixedly connected to the carrier 301a. At least one connection hole M in the first connector 301b may include a first connection hole M1. At least two connection holes M in the second connector 301c may include a second connection hole M2 and a third connection hole M3.

The adjusting screw 302c in the adjustment assembly 300 may include a first screw 302cl corresponding to the first connection hole M1, a second screw 302c2 corresponding to the second connection hole M2, and a third screw 302c3 corresponding to the third connection hole M3. The line connecting the axis of the first connection hole M1 and the axis of the second connection hole M2 may be parallel to the length direction of the lens 400, and the line connecting the axis of the second connection hole M2 and the axis of the third connection hole M3 may be perpendicular to the length direction of the lens 400. Here, the elastic elements 302b may include a first elastic element 302b1 corresponding to the first screw 302cl, a second elastic element 302b2 corresponding to the second screw 302c2, and a third elastic element 302b3 corresponding to the third screw 302c3.

The light source system 000 of the embodiments is configured such that: when the screwing depth of the first screw 302cl in the corresponding threaded hole is the same as the screwing depth of the second screw 302c2 in the corresponding threaded hole, the third screw 302c3 is controlled to move within the corresponding threaded hole, causing the carrier 301a to rotate around an axis parallel to the length direction of the lens 400; and when the screwing depth of the second screw 302c2 in the corresponding threaded hole is the same as the screwing depth of the third screw 302c3 in the corresponding threaded hole, the first screw 302cl is controlled to move within the corresponding threaded hole, causing the carrier 301a to rotate around an axis perpendicular to the length direction of the lens 400.

In this way, when the operator controls the first screw 302cl to move along the first target direction X1, the first elastic element 302b1 can be made to release elastic force, causing the first connector 301b to move along the first target direction X1. Since the second screw 302c2 and the third screw 302c3 can be threadedly connected to the corresponding support posts 302a, in this case, the position of the second connector 301c on the line connecting the axis of the second connecting hole M2 and the axis of the third connecting hole M3 remains unchanged. Thus, under the action of the elastic force released by the first elastic element 302b1, the first connector 301b can rotate around the line connecting the axis of the second connecting hole M2 and the axis of the third connecting hole M3, which in turn can drive the bracket 301 to rotate around the line connecting the axis of the second connecting hole M2 and the axis of the third connecting hole M3. Under the drive of the bracket 301, the lens 400 can rotate around the line connecting the axis of the second connection hole M2 and the axis of the third connection hole M3. When the operator controls the second screw 302c2 and the third screw 302c3 to move along the first target direction X1, the second elastic element 302b2 and the third elastic element 302b3 can be made to release elastic force, causing the second connector 301c to move along the first target direction X1. Since the first connector 301b can be threadedly connected to the corresponding support post 302a, in this case, the position of the first connector 301b at the corresponding support post 302a remains unchanged. Thus, under the action of the elastic force released by the second elastic element and the third elastic element, the second connector 301c can rotate around an axis perpendicular to the length direction of the lens 400. In this way, the operator only needs to move the first screw 302cl or the second screw 302c2 and the third screw 302c3 in the first target direction X1 to make the bracket 301 drive the lens 400 to rotate around the length direction or width direction of the lens 400, thereby enabling the color of the projection image projected by the projection lens to be adjusted. Here, to ensure that the second connector can rotate stably around the axis perpendicular to the length direction of the lens 400, the distances that the second screw 302c2 and the third screw 302c3 move along the first target direction X1 should be the same.

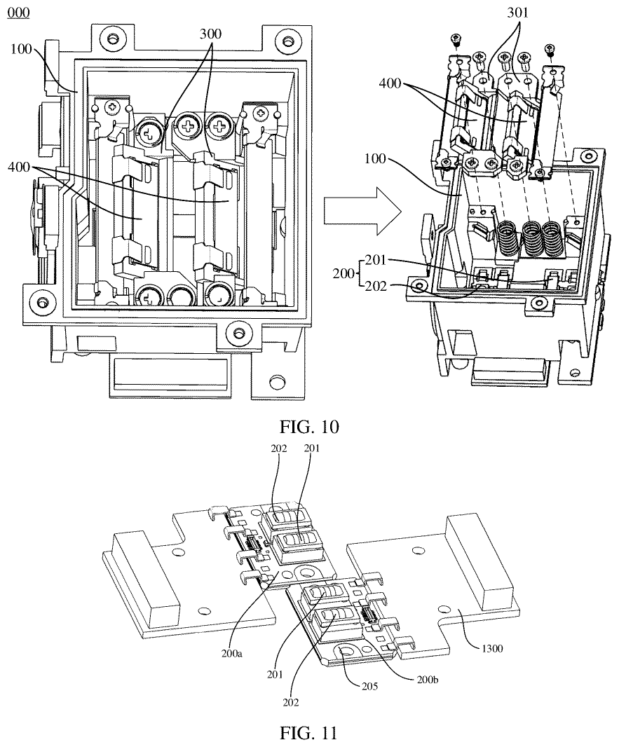

In some embodiments, referring to FIG. 11, the light source system 000 may include two laser devices 200. The two laser devices 200 may be a first laser device 200a and a second laser device 200b. Here, the first laser device 200a may be closer to the optical engine system in the laser projection device relative to the second laser device 200b.

Both the first laser device 200a and the second laser device 200b may each have a row of first laser units 201 and a row of second laser units 202, the plurality of lenses 400 may include two first lenses 401 disposed on the light-output sides of the row of first laser units 201 in the first laser device 200a and the second laser device 200b, and two second lenses 402 disposed on the light-output sides of the row of second laser units 202 in the first laser device 200a and the second laser device 200b. In this way, it can be ensured that the operator can not only solve the color cast problem in the target image projected by the laser projection device by adjusting the posture of the first lens 401, but also improve the brightness of the projection image projected by the laser projection device.

It should be noted that, as shown in FIG. 11, the first laser device 200a and the second laser device 200b may be arranged in a centrally symmetric manner. That is, in the first laser device 200a and the second laser device 200b, two rows of first laser units 201 may be arranged adjacently, and these two rows of first laser units 201 may both be disposed between two rows of second laser units 202, enabling the two adjustment assemblys 300 corresponding to the two laser devices 200 to also be arranged in a centrally symmetric manner. Since the shape of the adjustment member 301 in the adjustment assembly 300 may be L-shaped, the centrally symmetric form can fully utilize the light source system 000, resulting in a small volume of the light source system 000.

In the embodiments of the present disclosure, since the two laser devices 200 may include first laser units 201 that emits blue laser beam and green laser beam and second laser units 202 that emits red laser beam, when the two laser devices 200 are symmetrically distributed, the arrangement of the laser units may be a second laser unit 202, a first laser unit 201, a first laser unit 201, and a second laser unit 202.

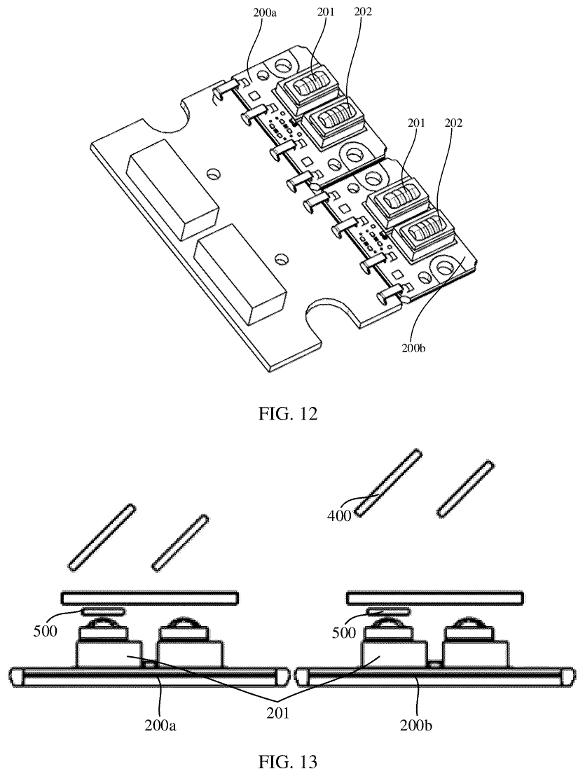

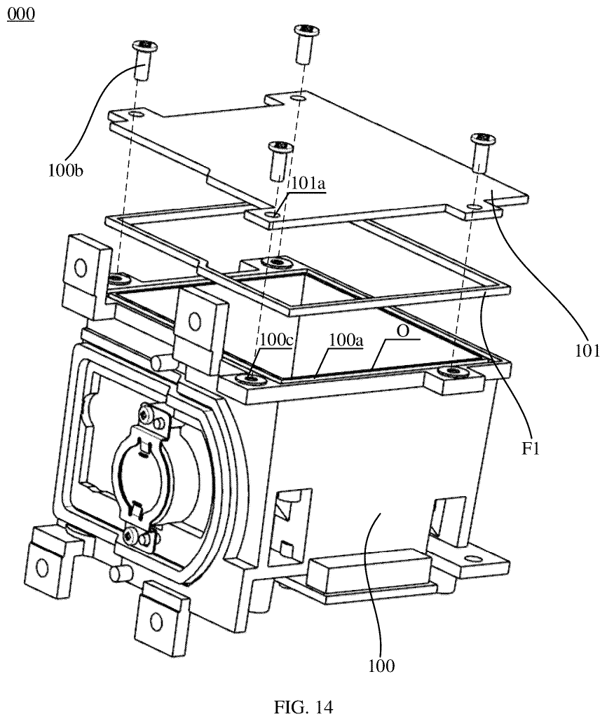

It should be noted that the embodiments of the present disclosure are illustrative examples based on the arrangement of the first laser device 200a and the second laser device 200b as shown in FIG. 12. In other possible implementations, as shown in FIG. 13, the first laser device 200a and the second laser device 200b may be arranged side by side, and the arrangement of one row of first laser units 201 and one row of second laser units 202 in the first laser device 200a is the same as the arrangement of one row of first laser units 201 and one row of second laser units 202 in the second laser device 200b. That is, in the first laser device 200a and the second laser device 200b, the two rows of first laser units 201 and the two rows of second laser units 202 are arranged in a staggered manner.

In the present disclosure, the polarization polarity of the blue laser beam and green laser beam emitted by the first laser unit 201 in the laser device 200 is opposite to the polarization polarity of the red laser beam emitted by the second unit. For example, the blue laser beam and green laser beam are S-polarized light, while the red laser beam is P-polarized light. For this purpose, referring to FIG. 13, the light source system 000 may further include: a polarization conversion component 500. The polarization conversion component 500 may be disposed between the laser device 200 and the lens 400, corresponds to the first laser unit 201 in laser device 200, and is used to convert the incident blue laser beam and green laser beam from S-polarized light to P-polarized light, and then emit them to the lens 400 corresponding to the first laser unit 201. This ensures that the polarization directions of the blue laser beam and green laser beam entering other components in the laser projection device are the same as that of the red laser beam. In this way, the projection image formed by using a laser beam with a unified polarization direction can avoid the problem of color blocks in the formed projection image caused by the different transmission and reflection efficiencies of optical lens 400 for different polarized lights. For example, the polarization conversion component 500 may be a half-wave plate.

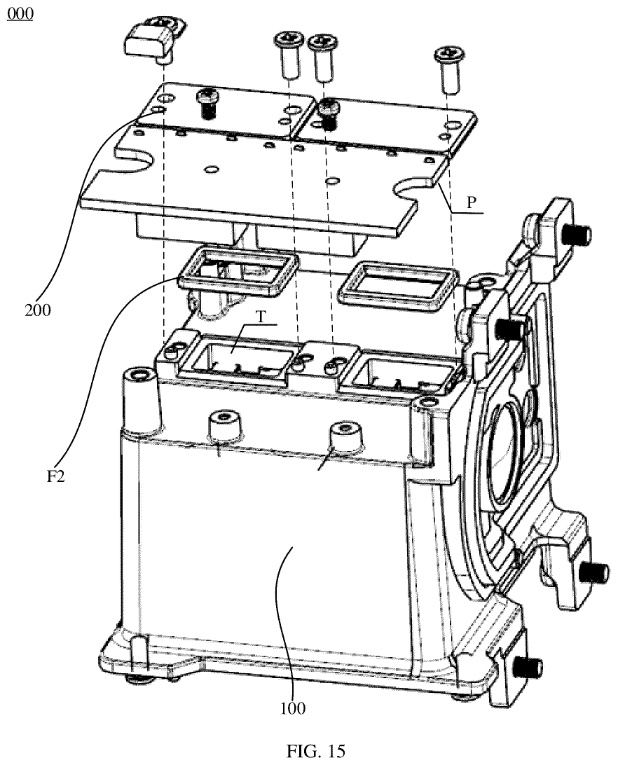

In some embodiments, referring to FIGS. 14 and 15, the light source system 000 may further include: a first sealing ring F1 and a second sealing ring F2. The first sealing ring F1 in the light source system 000 may be disposed at the assembly opening O, with the first sealing ring F1 in contact with both the housing 100 and the end cover 101. Here, the first sealing ring F1 can make the connection between the housing 100 and the end cover 101 more secure, thereby improving the airtightness of the light source system 000.

In some embodiments, the side of the housing 100 close to the first sealing ring F1 may be provided with a sealing groove 100a, and the sealing ring F1 may be assembled in the sealing groove 100a. Here, the housing may further be provided with a fastener 100b and a first fastening hole 100c mated with the fastener 100b, and the end cover 101 may be provided with a second fastening hole 101a communicating with the first fastening hole 100c. The fastener 100b may pass through the second fastening hole 101a and then be tightly connected to the first fastening hole 100c, such that the end cover 101 may be tightly connected with the housing 100. Since the end cover 101 can abut against the sealing ring F1, after the fastener 100b tightly connects the end cover 101 to the housing 100, the end cover 101 can press and secure the side of the first sealing ring F1 close to the housing 100 onto the housing 100, thereby making the connection between the housing 100 and the end cover 101 tighter.

The second sealing ring F2 may be disposed at the light-transmitting hole T, and the second sealing ring F2 may abut against both the housing 100 and the laser device 200. The beneficial effects of the second sealing ring F2 abutting against both the housing 100 and the laser device 200 may be referenced from the beneficial effects of the first sealing ring F1 abutting against both the housing 100 and the end cover 101, and will not be repeated here.

In related art, since the polarization modes of the red laser beam emitted by the light-emitting units of the two laser devices are the same, and the polarization modes of the blue laser beam and green laser beam emitted by the light-emitting units of the two laser devices are also the same, the laser beams emitted by the two laser devices will interfere with each other in the subsequent optical path, causing the laser beams to easily produce speckles in the subsequent optical path, thereby resulting in poor display quality of the projection image projected by the laser projection device.

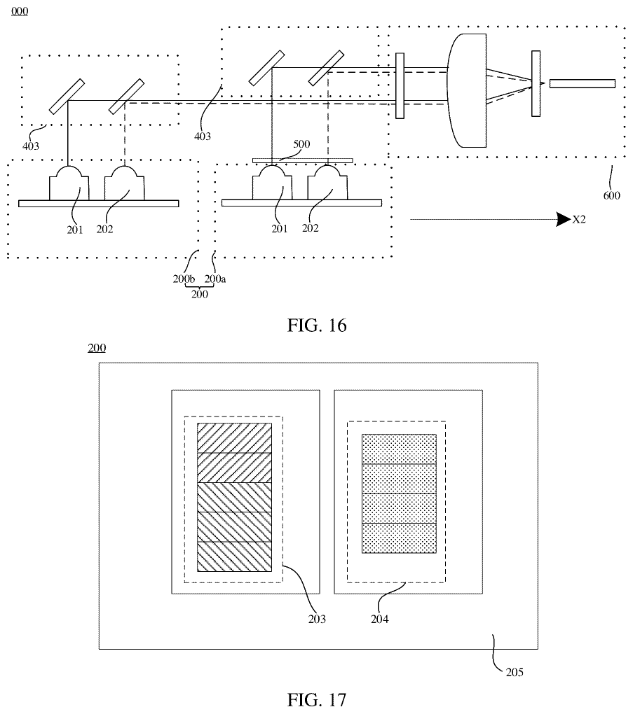

In some embodiments, referring to FIG. 16, the light source system 000 may include a polarization conversion component 500 and a light homogenizing assembly 600, and the number of laser devices 200 is two, with the lenses 400 including a light-combining lens group 403. To provide a clearer view of the structure of the laser device 200 in the light source system 000, referring to FIG. 17, each laser device 200 in the light source system 000 may include at least one row of first-type light-emitting units 203 for emitting first-type laser beams, and at least one row of second-type light-emitting units 204 for emitting second-type laser beams.

In some embodiments, as shown in FIG. 17, each laser device 200 may include a substrate 205, and first-type light-emitting units 203 and second-type light-emitting units 204 disposed on one side of the substrate 205. Here, some of the light-emitting units in a row of first-type light-emitting units 203 may emit a blue laser beam with a polarization mode of P-polarization mode, while other light-emitting units may emit a green laser beam with a polarization mode of P-polarization mode. Each of the light-emitting units in one row of second-type light-emitting units 204 may emit a red laser beam with a polarization mode of S-polarization mode. Since both the first-type light-emitting units 203 and the second-type light-emitting units 204 may be used to emit a laser beam, the side of the substrate 205 where the first-type light-emitting units 203 and the second-type light-emitting units 204 are arranged may serve as the light-output side of the laser device 200.

To ensure that the laser beams emitted by the two laser devices 200 do not interfere with each other, i.e., to reduce the coherence of the laser beam emitted by the two laser devices 200, the polarization conversion component 500 may be provided between at least one laser device 200 and the light-combining lens group.

In the present disclosure, as shown in FIG. 16, the polarization conversion component 500 may be disposed between the light-combining lens group 403 and at least one laser device 200, and the polarization conversion component 500 may be used to adjust the polarization mode of the laser beam emitted by at least one laser device 200, such that the polarization mode of the first-type laser beam emitted by one laser device 200 is different from the polarization mode of the first-type laser beam emitted by another laser device 200, and the polarization mode of the second-type laser beam emitted by one laser device 200 is different from the polarization mode of the second-type laser beam emitted by another laser device 200.

Thus, even if the polarization modes of the first-type laser beams emitted by the two laser devices 200 are the same, and the polarization modes of the second-type laser beams are also the same, after adjustment by the polarization conversion component, the degree of interference between the laser beams emitted by the two laser devices in the subsequent optical path is low, thereby reducing the probability of speckle generation in the laser beam in the subsequent optical path. This ensures that the projection image displayed by the laser projection device has a good display effect.

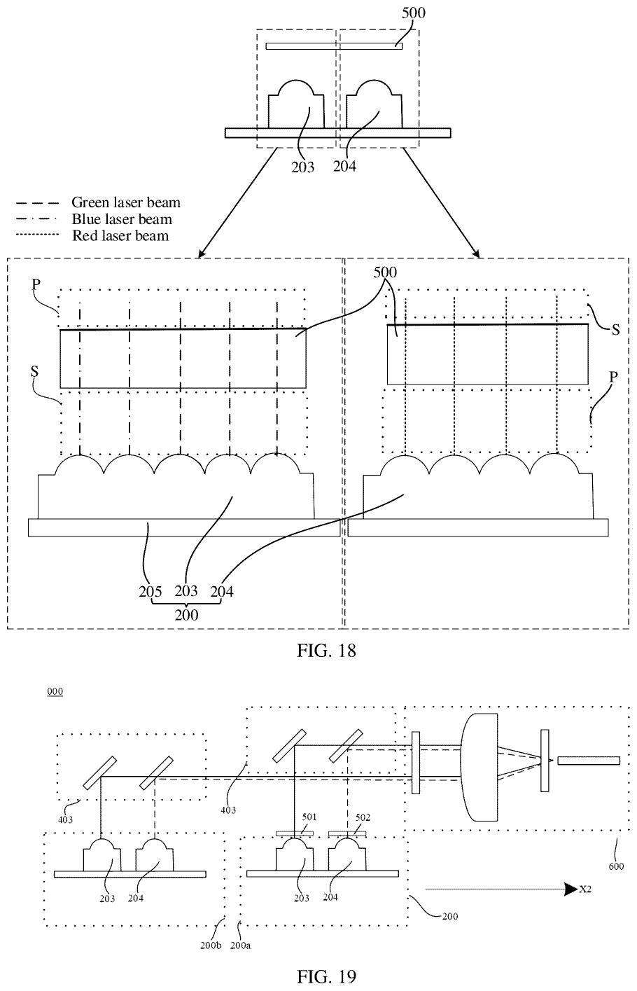

In some embodiments, as shown in FIG. 18, the polarization conversion component 500 can convert the red laser beam with P-polarization mode emitted by the second-type light-emitting units 204, into a red laser beam with S-polarization mode. The polarization conversion component 500 can also convert the blue laser beam and green laser beam with S-polarization mode emitted by the first-type light-emitting units 203 into blue laser beam and green laser beam with P-polarization mode. In this way, it can ensure that the degree of interference between the laser beams emitted by the two laser devices 200 in the subsequent optical path of the light source system 000 is relatively low.

The light-combining lens group 403 in the light source system 000 may be disposed on the light-output side of the two laser devices 200, and the light-combining lens group 403 is used to direct the laser beam adjusted by the polarization conversion component 500 to the light homogenizing component 600. Here, since the polarization conversion component 500 can adjust the laser beam emitted from the laser device 200, the degree of interference between the laser beams emitted by the two laser devices 200 in the subsequent optical path of the light source system 000 is relatively low. This reduces the probability of speckle generation in the subsequent optical path. Therefore, after the light-combining lens group 403 directs the laser beam adjusted by the polarization conversion component 500 to the light homogenizing assembly 600, the light homogenizing assembly 600 can more effectively homogenize the laser beam, thereby ensuring that the projection image projected by the laser projection device equipped with this light source system 000 has a good display effect.

The light source system provided by the embodiments of the present disclosure uses the polarization conversion component to adjust the polarization mode of the laser beam emitted by at least one laser device, such that the polarization mode of the first-type laser beam emitted by one laser device differs from that of the first-type laser beam emitted by another laser device, and the polarization mode of the second-type laser beam emitted by one laser device differs from that of the second-type laser beam emitted by another laser device. Thus, although the polarization modes of the first-type laser beam emitted by the two laser devices are the same, and the polarization modes of the second-type laser beam emitted by the two laser devices are also the same. After adjustment by the polarization conversion component, the degree of interference between the laser beams emitted by the two laser devices in the subsequent optical path is low, reducing the probability of speckle generation in the subsequent optical path, thereby ensuring that the projection image projected by the laser projection device has a good display effect.

In some embodiments, referring to FIG. 19, the polarization conversion component 500 in the light source system 000 may include a first polarization conversion lens 501 covering at least part of the first-type light-emitting units 203, and a second polarization conversion lens 502 covering at least part of the second-type light-emitting units 204. In some embodiments, during the assembly of the light source system 000, the operator can conveniently install the polarization conversion component 500 based on the positions of the rows of light-emitting units in the laser device 200, such that the first polarization conversion lens 501 covers one row of first-type light-emitting units 203, and the second polarization conversion lens 502 covers one row of second-type light-emitting units 204. There is no need to use a large polarization conversion lens to cover the laser device 200, which can reduce the assembly difficulty of the polarization conversion component 500, reduce the manufacturing cost of the light source system 000 can be reduced, and make the placement of the laser device 200 in the light source system 000 more flexible, thereby ensuring that the volume of the light source system 000 is small. Here, the number of first polarization conversion lenses 501 and the number of the second polarization conversion lenses 502 may each be one, and one laser device 200 may include one row of first-type light-emitting units 203 and one row of second-type light-emitting units 204.

In some embodiments, the number of laser devices 200 may be two, and each of the two laser devices 200 may have at least one row of first-type light-emitting units 203 and at least one row of second-type light-emitting units 204. Since the polarization conversion component 500 only needs to cover at least one row of first-type light-emitting units 203 on any one of the two laser devices 200 and at least one row of second-type light-emitting units 204 on any one of the two laser devices 200, there can be multiple possible implementations for the positional relationship between the polarization conversion component 500 and the laser devices 200.

In some embodiments, as shown in FIG. 19, the first polarization conversion lens 501 and the second polarization conversion lens 502 in the polarization conversion component 500 may be disposed on the light-output side of the same laser device 200a, and be staggered from the light-output side of the other laser device 200b.

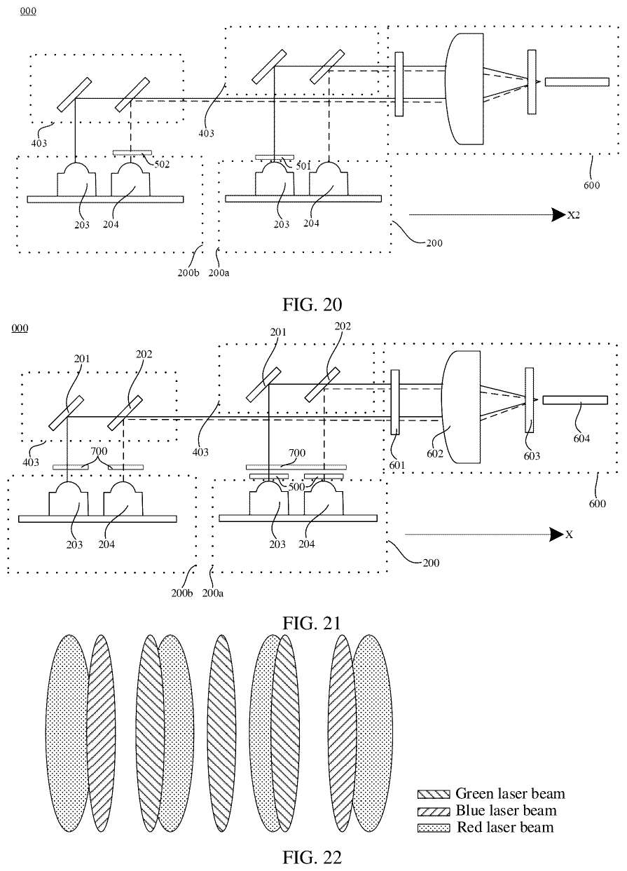

In some embodiments, as shown in FIG. 20, the first polarization conversion lens 501 in the polarization conversion component 500 may cover at least one row of first-type light-emitting units 203 in one laser device 200a, and the second polarization conversion lens 502 may cover at least one row of second-type light-emitting units 204 in one laser device 200b. When the two laser devices 200 have multiple rows of first-type light-emitting units 203 and multiple rows of second-type light-emitting units 204, the first polarization conversion lens 501 may cover all of the first-type light-emitting units 203 in one laser device 200a, and the second polarization conversion lens 502 may cover all of the second-type light-emitting units 204 in the other laser device 200b.

In this way, it can be ensured that the laser beams of the same color emitted by the two laser devices 200 can have different polarization modes after being adjusted by the polarization conversion component 500. In addition, the operator can flexibly determine the installation positions of the first polarization conversion lens 501 and the second polarization conversion lens in the polarization conversion component 500 based on the actual situation during the assembly process of the light source system 000. This also makes the position of the laser 200 in the light source system 000 more flexible, thereby ensuring that the volume of the light source system 000 is small.

In some embodiments, referring to FIG. 21, the light source system 000 may further include two prism assemblies 700 corresponding to the two laser devices 200. To provide a clearer view of how the prism assembly 700 cooperates with the laser device 200, referring to FIG. 21, the prism assembly 700 in the light source system 000 may be disposed between the laser device 200 and the light-combining lens group 403 in the light source system 000. The prism assemblies 700 may be used to adjust the laser beam emitted from each row of light-emitting units in the laser device 200. It should be noted that after adjusting the laser beam emitted by the laser device 200, the prism assembly 700 may also direct the adjusted laser to the light-combining lens group 403.

In the laser beam emitted by one row of light-emitting units, the first laser beam L1 emitted by the first light-emitting unit Y1 is located on one side of the second laser beam L2 emitted by the second light-emitting unit Y2 before being adjusted by the prism assembly 700. After being adjusted by the prism assembly 700, the first laser beam L1 is located on the other side of the second laser beam L2. The first light-emitting unit Y1 and the second light-emitting unit Y2 are light-emitting units disposed on both sides of one row of light-emitting units.

In this way, even if restricted by the structure of the laser device 200, the laser beam emitted from the laser device 200 may be adjusted using the prism assembly 700, such that the laser beam of different colors emitted by the laser device 200 can be evenly distributed. Furthermore, the laser beam of different colors can be mixed before being emitted to the light-combining lens group 403.

In some embodiments, as shown in FIGS. 17 and 18, when the first-type light-emitting units 203 in the laser device 200 include two consecutive light-emitting units for emitting blue light and three consecutively arranged green light-emitting units, with the light-emitting units for emitting blue light and the green light-emitting units being respectively disposed on both sides of the first-type light-emitting units 203. The laser beams emitted by the first-type light-emitting units 203 are distributed in the order of blue-blue-green-green-green before being adjusted by the prism assembly 700. After adjustment by the prism assembly 700, the adjusted lasers can be distributed in the order of blue-green-green-green-blue. In this way, through the adjustment of the laser beam emitted by the laser device 200 by the prism assembly 700, the problem that the blue laser beam and green laser beam emitted by the laser device 200 are relatively independent can be effectively avoided.

The light-combining lens group 403 in the light source system 000 may be used to direct the laser beam adjusted by the prism assembly 700 to the light homogenizing assembly 600. Here, since the prism assembly 700 can adjust the laser beam emitted from the laser device 200, enabling the green laser beam and blue laser beam emitted by the laser device 200 to be evenly distributed, the green laser beam and blue laser beam can be mixed before being emitted toward the light-combining lens group 403. Therefore, after the light-combining lens group 403 directs the laser beam adjusted by the prism assembly 700 to the light homogenizing assembly 600, the light homogenizing assembly 600 can better homogenize the laser beam, resulting in a better homogenization effect of the laser beam emitted by the laser device 200 through the light homogenizing assembly 600. Furthermore, this can ensure that the projection image projected by the laser projection device equipped with the light source system 000 has a good display effect.

It should be noted that, as shown in FIG. 17, since the positions of each row of light-emitting units in the laser device 200 are matched with each other, the laser beam emitted by the first-type light-emitting unit 203 after adjustment by the prism assembly 700 is offset from the laser beam emitted by the first-type light-emitting unit 203 before adjustment by the prism assembly 700. To ensure a good homogenization effect of the laser beam emitted by the laser device 200 through the light homogenizing assembly 600, while adjusting the laser beam emitted from the first-type light-emitting units 203 in the laser device 200 through the prism assembly 700, it is necessary to adjust the laser beam emitted from the second-type light-emitting units 204b in the laser device 200 through the prism assembly 700. This ensures that the distribution of laser beam emitted from each row of light-emitting units in the laser device 200 after exiting the prism assembly 700 is matched with each other, thereby enabling these laser beams to be better combined by the light-combining lens group 403 and further improving the homogenization effect of the laser beam emitted by the laser device 200 through the light homogenizing assembly 600.

In some embodiments, as shown in FIG. 18, the first-type light-emitting units 203 in the laser device 200 include two light-emitting units for emitting blue light and three light-emitting units for emitting green light, and the second-type light-emitting units 204 in the laser device 200 include four light-emitting units for emitting red light. Referring to FIG. 22, after adjusting the laser beam emitted by the first-type light-emitting units 203 and the second-type light-emitting units 204 simultaneously through the prism assembly 700, and after these adjusted laser beams are directed by the light-combining lens group 403 to the light homogenizing assembly 600, the laser beams of various colors can be evenly distributed, resulting in a more uniform light spot after the laser beams are mixed, thereby ensuring that the laser beams provided by the light source system 000 has high quality.

In some embodiments, as shown in FIG. 21, the prism assembly 700 may be a single prism capable of simultaneously covering all the light-emitting units in the laser device 200. To reduce the assembly difficulty of the prism assembly 700 in the light source system 000, the prism assembly 700 may include at least two prisms.

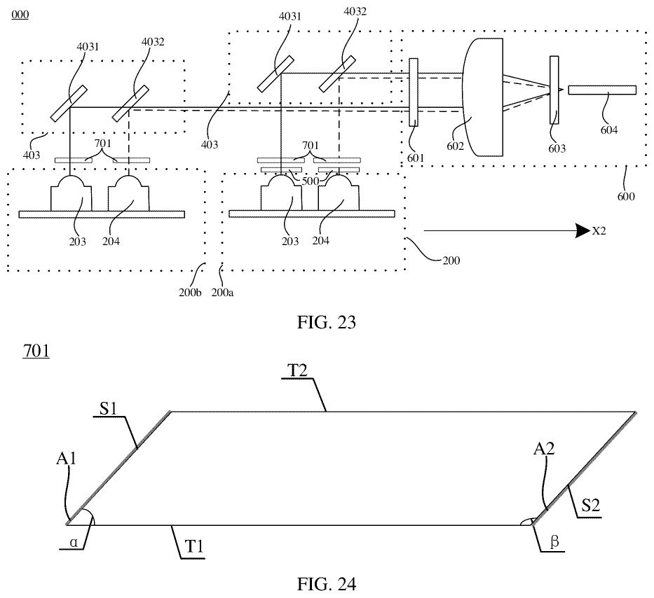

In some embodiments, as shown in FIGS. 23 and 24, the prism assembly 700 may include at least two prisms 701 corresponding to at least two rows of light-emitting units in the laser device 200, with each prism 701 covering the corresponding row of light-emitting units. In this way, during the installation process of the light source system 000, the operator can install the prisms 701 more conveniently according to the positions of the rows of light-emitting units in the laser device 200, thereby reducing the assembly difficulty of the prism assembly 700. As shown in FIG. 21 or FIG. 23, the prism assembly 700 in the light source system 000 may be two, and the laser device 200 may include two rows of light-emitting units. The two prisms 701 may be disposed on the light-outside sides of the two rows of light-emitting units in the laser device 200.

The prism 701 in the prism assembly 700 can have a first reflective surface S1 and a second reflective surface S2 arranged oppositely. The first reflective surface S1 is used to direct the first laser beam L1 emitted from the first light-emitting unit Y1 to the second reflective surface S2, and the second reflective surface S2 is used to direct the first laser beam L1 reflected by the first reflective surface S1 to the light-combining lens group 403. Through the first reflective surface S1 and the second reflective surface S2, the prism 701 in the prism assembly 700 can adjust the laser beam emitted by the corresponding row of light-emitting units, enabling the laser beam of different colors emitted by the laser device 200 to be evenly distributed.

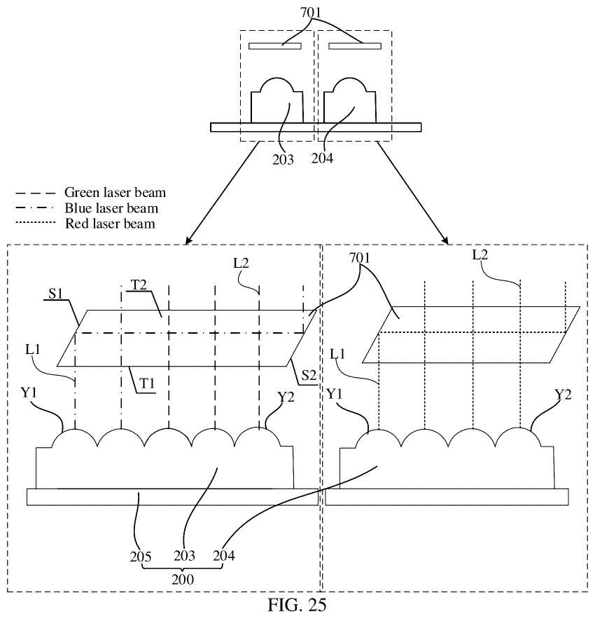

In some embodiments, as shown in FIG. 25, taking the first-type light-emitting units 203 that emit blue laser beam and green laser beam as an illustrative example, the first laser beam L1 emitted by the first light-emitting unit Y1 in the first-type light-emitting units 203 may be a blue laser beam, and the second laser beam L2 emitted by the second light-emitting unit Y2 in the first-type light-emitting units 203 may be a green laser beam. The first laser beam L1 may be directed toward the first reflective surface S1 of the prism 701, reflected by the first reflective surface S1 toward the second reflective surface S2 of the prism 701, and then reflected by the second reflective surface S2 toward the light-combining lens group 403. The incident point of the first laser beam L1 on the second reflective surface S2 may be located on the side of the second light-emitting unit Y2 that is away from the first light-emitting unit Y1. Before the laser beam emitted by the first-type light-emitting units 203 enter the corresponding prism 701, the first laser beam L1 is distributed on one side of the second laser beam L2; after the laser beam emitted by the first-type light-emitting units 203 exit from the corresponding prism 701, the first laser beam L1 is distributed on the other side of the second laser beam L2. In this way, the prism 701 can enable the green laser beam and blue laser beam emitted by the laser device 200 to be evenly distributed.

In some embodiments, referring to FIGS. 24 and 25, the prism 701 also has a first light-transmitting surface T1 and a second light-transmitting surface T2 arranged oppositely. The first light-transmitting surface T1 is closer to the laser device 200 than the second light-transmitting surface T2. Here, the prisms 701 in the prism assembly 700 only adjust the distribution position of the first laser beam L1 and do not adjust the emission direction of the laser beam. That is, the transmission direction of the laser beam before entering prism 701 is parallel to the transmission direction of the laser beam emitted from prism 701. For this purpose, the light-combining lens group 403 in the light source system 000 is disposed on the side of the prism assembly 700 away from the laser device 200.

In some embodiments, to ensure that prism 701 does not adjust the transmission direction of the laser beam, it is necessary to ensure that the transmission direction of the first laser beam L1 incident on the first reflective surface S1 is perpendicular to the first light-transmitting surface T1, the first laser beam L1 transmitted between the first reflective surface S1 and the second reflective surface S2 is parallel to the first light-transmitting surface T1, and the first laser beam L1 reflected by the second reflective surface S2 is perpendicular to the second light-transmitting surface T2. To this end, the first light-transmitting surface T1 and the second light-transmitting surface T2 in prism 701 can be parallel to each other, and both need to be parallel to the light-output surface P of the laser device 200. Meanwhile, it is also necessary to ensure that the angle α between the first light-transmitting surface T1 and the first reflective surface S1 is 45°, and that the angle β between the first light-transmitting surface T1 and the second reflective surface S2 is 135°.

It should be noted that the first light-transmitting surface T1 of the prism 701 may fully cover all the light-emitting units in the corresponding row of light-emitting units, or may only cover part of the light-emitting units in the corresponding row of light-emitting units. Different covering methods will result in different optical paths for the light source system 000. For this reason, the embodiments of the present disclosure will take the following two possible implementations as examples for illustration:

In one possible implementation, as shown in FIG. 25, the first light-transmitting surface T1 of each prism 701 covers all the light-emitting units in the corresponding row of light-emitting units. Here, each light-emitting unit in each row, except for the first light-emitting unit Y1, simultaneously faces the first light-transmitting surface T1 and the second light-transmitting surface T2 of the corresponding prism 701, while the first light-emitting unit Y1 simultaneously faces the first light-transmitting surface T1 and the first reflective surface S1. That is, the first light-transmitting surface T1 and the first reflective surface S1 of the prism 701 both cover the first light-emitting unit Y1 in the corresponding row of light-emitting units, while the first light-transmitting surface T1 and the second light-transmitting surface T2 of the prism 701 simultaneously cover all light-emitting units in the corresponding row of light-emitting units except for the first light-emitting unit Y1.

In this case, the first laser beam L1 emitted by the first light-emitting unit Y1 in each row of light-emitting units can pass through the first light-transmitting surface T1, the first reflective surface S1, the second reflective surface S2, and the second light-transmitting surface T2 of the corresponding prism 701 in sequence before being directed toward the light-combining lens group 403. The laser beam emitted by each light-emitting unit in each row of the light-emitting units, except for the first light-emitting unit Y1, can pass through the first light-transmitting surface T1 and the second light-transmitting surface T2 in sequence before being directed toward the light-combining lens group 403. In this way, it can be ensured that the first laser beam L1 can change its original optical path after being adjusted by the prism 701 and be located on the other side of the second laser beam L2.

It should be noted that when the prism 701 is made of a material with a high refractive index, the first laser beam L1 directed toward the first reflective surface S1 can satisfy the total reflection condition, enabling the first laser beam L1 to be totally reflected by the first reflective surface S1 toward the second reflective surface S2. Moreover, the first laser beam L1 directed toward the second reflective surface S2 also satisfies the total reflection condition, enabling the first laser beam L1 to be totally reflected by the second reflective surface S2 toward the second light-transmitting surface T2.

However, when the prism 701 is made of a material with a low refractive index, the first laser beam L1 directed toward both the first reflective surface S1 and the second reflective surface S2 may fail to satisfy the total reflection condition. In this case, referring to FIG. 27, the prism assembly 700 may further include a reflective film A1 disposed on the first reflective surface S1 of each prism 701 and a reflective film A2 disposed on the second reflective surface S2 of each prism 701. In this way, the first laser beam L1 directed toward the first reflective surface S1 can be fully reflected by the reflective film A1 toward the second reflective surface S2, and the first laser beam L1 directed toward the second reflective surface S2 can be fully reflected by the reflective film A2 toward the second light-transmitting surface T2.

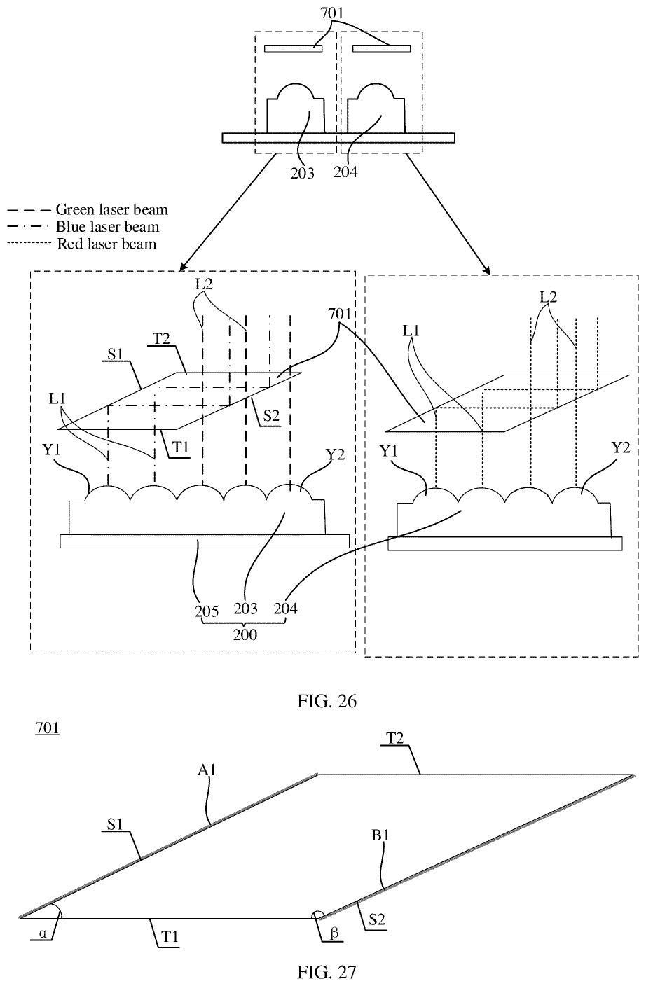

In another possible implementation, as shown in FIG. 26, the first light-transmitting surface T1 of each prism 701 may cover a portion of the light-emitting units in the corresponding row of light-emitting units, and be staggered from the other portion of the light-emitting units in the corresponding row of light-emitting units. Here, all light-emitting units in each row of light-emitting units, except for the first light-emitting unit Y1, are simultaneously directed toward the second reflective surface S2 and the second light-transmitting surface T2, and the first light-emitting unit Y1 is simultaneously directed toward the first light-transmitting surface T1 and the first reflective surface S1. That is, the first light-transmitting surface T1 and the first reflective surface S1 of the prism 701 both cover the first light-emitting unit Y1 in the corresponding row of light-emitting units, and the second reflective surface S2 and the second light-transmitting surface T2 of the prism 701 both cover the light-emitting units in the corresponding row of light-emitting units except for the first light-emitting unit Y1.

In this case, the first laser beam L1 emitted by the first light-emitting unit Y1 in each row of light-emitting units can pass through the first light-transmitting surface T1, the first reflective surface S1, the second reflective surface S2, and the second light-transmitting surface T2 of the corresponding prism 701 in sequence before being directed toward the light-combining lens group 403. The laser beam emitted by each light-emitting unit in each row of light-emitting units, except for the first light-emitting unit Y1, can pass through the second reflective surface S2 and the second light-transmitting surface T2 in sequence before being directed toward the light-combining lens group 403. In this way, it can be ensured that the first laser beam L1 can change its original optical path after being adjusted by the prism 701 and be located on the other side of the second laser beam L2.

Taking the first-type light-emitting units 203 as an illustrative example, each light-emitting unit for emitting blue light in the first-type light-emitting units 203 is a first light-emitting unit Y1, and each light-emitting unit in the first-type light-emitting units 203, except the first light-emitting unit Y1, is used for emitting green light. As shown in FIG. 26, the laser beams emitted by the first-type light-emitting units 203 are distributed in the order of blue-blue-green-green-green before being adjusted by the prism assembly 700; after adjustment by the prism assembly 700, the adjusted laser beams can be distributed in the order of green-blue-green-blue-green. In this way, through the adjustment of the laser beams emitted by the laser 200 by the prism assembly 700, the first laser beams L1 can be evenly distributed among the second laser beams L2.

In some embodiments, when the prism 701 is made of a material with a low refractive index, as shown in FIG. 27, the prism assembly 700 may further include a reflective film A1 disposed on the first reflective surface S1 of each prism 701 and a dichroic film B1 disposed on the second reflective surface S2 of each prism 701. In this way, the first laser beam L1 directed toward the first reflective surface S1 can be fully reflected by the reflective film A1 toward the second reflective surface S2. Here, the dichroic film B1 may be a thin film used to reflect light of one wavelength and transmit light of another wavelength. Since the first light-emitting units Y1 in the first light-emitting unit 203 are all used to emit blue light, and the other light-emitting units are all used to emit green light, the laser beams emitted by these green light-emitting units can be directly directed toward the second reflective surface S2. Therefore, the dichroic film B1 may be a thin film that reflects blue light and transmits green light. In this way, the first laser beam L1 (the first laser beam L1 is blue laser beam) directed toward the second reflective surface S2 may be reflected by the dichroic film B1 toward the second light-transmitting surface T2, and the green laser beam directly directed toward the second reflective surface S2 may pass through the dichroic film B1 and enter the prism 701 from the second reflective surface S2.

It should be noted that the wavelengths of the red laser beams emitted by the individual light-emitting units in the second-type light-emitting unit 204 may be different. Therefore, the dichroic film B1 can be a thin film that reflects one wavelength of red light and transmits another wavelength of red light, enabling the prism 701 to also adjust the red laser beams emitted by the second-type light-emitting unit.

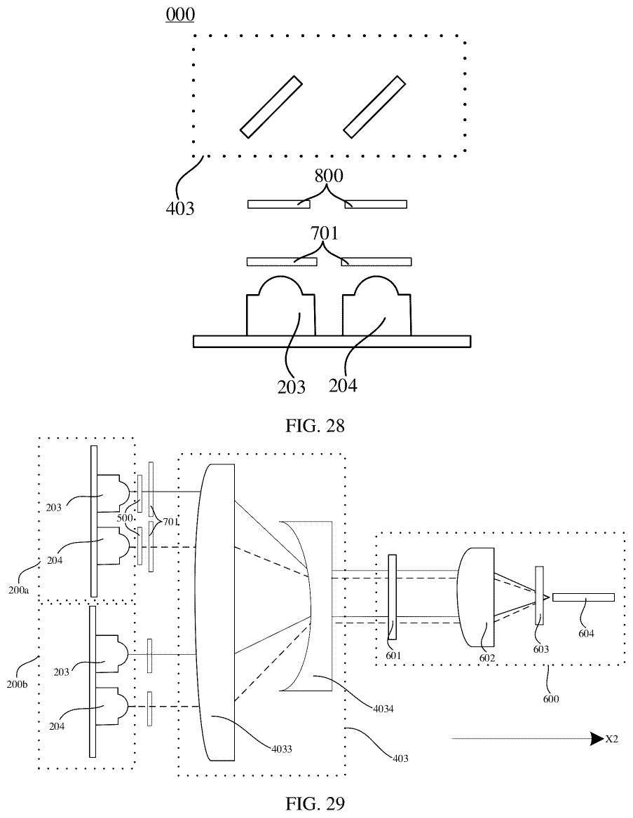

It should also be noted that, as shown in FIG. 26, after adjustment by the prism 701, the first laser beams L1 are evenly distributed between the second laser beams L2 emitted by the second light-emitting units. Therefore, the spot sizes of the laser beams after adjustment by prism 701 are smaller. In this case, as shown in FIGS. 26 and 28, the light source system 000 may further include a cylindrical lens 800 disposed between the prism assembly 700 and the light-combining lens group 403. The cylindrical lens 800 may cover the second light-transmitting surface T2 of each prism 701 in the prism assembly 700. The cylindrical lens 800 can expand the laser beams and direct them to the light-combining lens group 403, which can then direct the expanded laser beams to the light homogenizing assembly 600. Since the cylindrical lens 800 can expand the laser beams, the distance between individual laser beams is increased, ensuring that the light spots of the laser beams in subsequent optical paths are relatively large, thereby enabling the light homogenizing assembly 600 to achieve a better light homogenization effect on the laser beams.

In some embodiments, the cylindrical lens 800 may also be disposed between the light-combining lens group 403 and the light homogenizing assembly 600. The cylindrical lens 800 may cover the light-output surface of the light-combining lens group 403. Here, the laser beams combined by the light-combining lens group 403 may be directed to the cylindrical lens 800, which can expand the laser beams and direct them to the light homogenizing assembly 600.

In some embodiments, referring to FIGS. 21 and 23, the light source system 000 may include two laser devices 200 and two prism assemblies 700. The number of light-combining lens groups 403 is at least one. The two prism assemblies 700 are in one-to-one correspondence with the two laser devices 200. Each prism assembly 700 is used to adjust the laser beam emitted from the corresponding laser device 200 and can direct the adjusted laser beam to at least one light-combining lens group 403. In this way, the uniformity of each laser beam directed toward the light-combining lens group 403 can be ensured, thereby improving the brightness of the projection image displayed by the laser projection device.

In some embodiments, since the number of the laser devices 200 is two, the relative positions of the laser devices 200 and the light-combining lens group 403 may have multiple configurations, and the structure and the number of the light-combining lens group 403 may also have multiple possible implementations. Here, the embodiments of the present disclosure will take the following four optional implementations as examples to schematically illustrate the combination types of the laser device 200 and the light-combining lens group 403 in the light source system 000:

In some possible implementations, as shown in FIG. 23, when the two laser devices 200 in the light source system 000 are arranged sequentially along the second target direction X2, and the light-output sides of the two laser devices 200 face the same side, the number of light-combining lens groups 403 in the light source system 000 is two, and the two light-combining lens groups 403 are in one-to-one correspondence with the two laser devices 200. Each light-combining lens group 403 may be disposed on the light-output side of the corresponding laser device 200. Each light-combining lens group 403 may include a first light-combining lens 4031 and a second light-combining lens 4032 arranged sequentially along the second target direction X2, with the second light-combining lens 4032 being closer to the light homogenizing assembly 600 than the first light-combining lens 4031. The first light-combining lens 4031 may cover the first-type light-emitting unit 203 in the laser device 200, and the second light-combining lens 4032 may cover the second-type light-emitting unit 204 in the laser device 200. In this way, the first-type light-emitting unit 203 in the laser device 200 may emit blue laser beam and green laser beam toward the first light-combining lens 4031, and the first light-combining lens 4031 may reflect the blue laser beam and green laser beam toward the light homogenizing assembly 600. The second-type light-emitting unit 204 in the laser device 200 may emit a red laser beam toward the second light-combining lens 4032, the second light-combining lens 4032 may reflect the red laser beam toward the light homogenizing assembly 600, and the second light-combining lens 4032 may transmit the blue laser beam and the green laser beam reflected by the first light-combining lens 4031. In this way, through the cooperation of the first light-combining lens 4031 and the second light-combining lens 4032, the laser beams emitted by the two laser devices 200 can be simultaneously converged onto the light homogenizing assembly 600.

For example, the first light-combining lens 4031 in the light-combining lens assembly 403 may be a reflecting mirror for reflecting light of all colors, or a dichroic filter for reflecting blue and green laser beams while transmitting laser beams of other colors. The second light-combining lens 4032 may be a dichroic filter for reflecting red laser beams while transmitting laser beams of other colors.

In some possible implementations, as shown in FIG. 29, when the arrangement direction of the two laser devices 200 in the light source system 000 is perpendicular to the second target direction X2, and the light-output sides of the two laser devices 200 face the same side, the number of light-combining lens groups 403 in the light source system 000 is one, and the light-output sides of the two laser devices 200 may simultaneously face the light-combining lens group 403. The light-combining lens group 403 may include a third light-combining lens 4033 and a fourth light-combining lens 4034 arranged sequentially along the second target direction X2. The third light-combining lens 4033 may simultaneously cover the light-output surfaces of the two laser devices 200, and the fourth light-combining lens 4034 is closer to the light homogenizing assembly 600 relative to the third light-combining lens 4033. Here, the third light-combining lens 4033 may be a convex lens, and the fourth light-combining lens 4034 may be a concave lens. Thus, through the cooperation of the third light-combining lens 4033 and the fourth light-combining lens 4034, the laser beams emitted by the two laser devices 200 can be simultaneously converged onto the light homogenizing assembly 600.

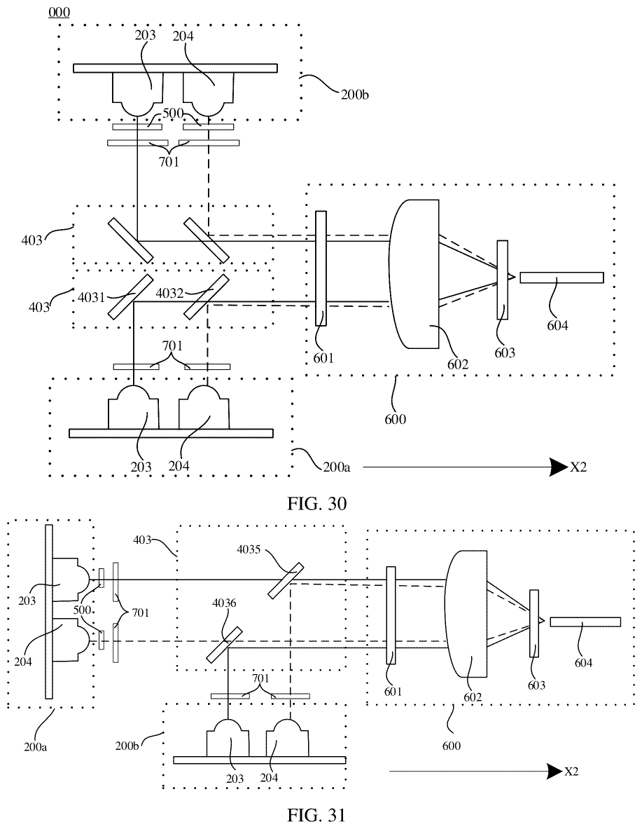

In some possible implementations, as shown in FIG. 30, when the two laser devices 200 in the light source system 000 are arranged perpendicular to the second target direction X2, and the light-output sides of the two laser devices 200 are arranged oppositely, the number of light-combining lens groups 403 in the light source system is two, and the two light-combining lens groups 403 are in one-to-one correspondence with the two laser devices 200. Each light-combining lens group 403 may be disposed on the light-output side of the corresponding laser device 200. Here, each light-combining lens group 403 may include a first light-combining lens 4031 and a second light-combining lens 4032 arranged sequentially along the second target direction X2, with the second light-combining lens 4032 being closer to the light homogenizing assembly 600 than the first light-combining lens 4031. The first light-combining lens 4031 may cover the first-type light-emitting unit 203 in the laser device 200, and the second light-combining lens 4032 may cover the second-type light-emitting unit 204 in the laser device 200. In this way, the first-type light-emitting unit 203 in the laser device 200 can emit blue laser beam and green laser beam to the first light-combining lens 4031, and the first light-combining lens 4031 can reflect the blue laser beam and green laser beam toward the light homogenizing assembly 600. The second light-emitting unit 204 in the laser device 200 can emit a red laser beam toward the second light-combining lens 4032, the second light-combining lens 4032 can reflect the red laser beam toward the light homogenizing assembly 600, and the second light-combining lens 4032 can transmit the blue laser beam and green laser beam reflected by the first light-combining lens 4031. In this way, through the cooperation of the first light-combining lens 4031 and the second light-combining lens 4032, the laser beams emitted by the two laser devices 200 can be simultaneously converged onto the light homogenizing assembly 600. Here, since the two laser devices are arranged oppositely in the third implementation, this implementation can effectively utilize the space inside the light source system 000, thereby reducing the volume of the light source system 000 and further reducing the volume of the laser projection device.

In some possible implementations, as shown in FIG. 31, the two laser devices 200 in the light source system 000 are the first laser device 200a and the second laser device 200b, and the light-output surfaces of the first laser device 200a and the second laser device 200b are perpendicular to each other. In this case, the number of light-combining lens groups 403 in the light source system 000 is one, and the light-output sides of the first laser device 200a and the second laser device 200b may both face the light-combining lens group 403. The arrangement direction of the first laser device 200a and the light-combining lens group 403 is parallel to the second target direction X2, and the arrangement direction of the second laser device 200b and the light-combining lens group 403 is perpendicular to the second target direction X2. Here, the light homogenizing assembly 600 is disposed on the side of the light-combining lens group 403 away from the first laser device 200a. This light-combining lens group 403 may include a sixth light-combining lens 4036 and a fifth light-combining lens 4035 arranged sequentially along the second target direction X2. The sixth light-combining lens 4036 can simultaneously cover the second-type light-emitting unit 204 in the first laser device 200a and the first-type light-emitting unit 203 in the second laser device 200b, while the fifth light-combining lens 4035 can simultaneously cover the first-type light-emitting unit 203 in the first laser device 200a and the second-type light-emitting unit 204 in the second laser device 200b. In this way, the first-type light-emitting unit 203 in the first laser device 200a can emit a blue laser beam and a green laser beam toward the fifth light-combining lens 4035, and the second-type light-emitting unit 204 in the second laser device 200b can emit a red laser beam toward the fifth light-combining lens 4035. The fifth combining lens 4035 can reflect the blue laser beam and green laser beam toward the light homogenizing assembly 600 and transmit the red laser beam toward the light homogenizing assembly 600. The second light-emitting unit 204 in the first laser device 200a can emit red laser beam to the sixth combining lens 4036, the first light-emitting unit 203 in the second laser device 200b can emit blue laser beam and green laser beam toward the sixth light-combining lens 4036, and the sixth light-combining lens 4036 can reflect red laser beam toward the light homogenizing assembly 600 and transmit blue laser beam and green laser beam toward the light homogenizing assembly 600. In this way, through the cooperation of the fifth light-combining lens 4035 and the sixth light-combining lens 4036, the laser beams emitted by the two laser devices 200 can be simultaneously converged onto the light homogenizing assembly 600.

In some embodiments, the fifth light-combining lens 4035 in the light-combining lens group 403 may be a dichroic filter used to reflect blue a laser beam and a green laser beam and transmit laser beams of other colors, and the sixth light-combining lens 4036 may be a dichroic filter used to reflect a red laser beam and transmit laser beams of other colors.

In the present disclosure, as shown in FIGS. 23, 29, 30, and 31, the light homogenizing assembly 600 in the light source system 000 may include a diffuser 601, a condenser lens 602, a diffusion wheel 603, and a light pipe 604 arranged sequentially along the second target direction X2. The diffuser 601 is closer to the light-combining lens group 403 than the condenser lens 602, diffusion wheel 603, and light pipe 604. The diffuser 601 can initially homogenize the laser beam from the light-combining lens group 403 and direct the initially homogenized laser beam toward the condenser lens 602. The condenser lens 602 may be disposed between the diffuser 601 and the diffusion wheel 603. The condenser lens 602 can converge the initially homogenized laser beam from the diffuser 601 and direct the converged laser beam toward the diffusion wheel 603 in the light homogenizing assembly 600. The diffusion wheel 603 can further homogenize the laser beams from the condenser lens 602 and direct the further homogenized laser beams to the light pipe 604. The light pipe 604 can finally homogenize the laser beam further homogenized by the diffusion wheel 603, resulting in a good homogenization of the laser beams. It should be noted that the above-mentioned second target direction X2 may be the extension direction of the light pipe 604.

On the other hand, the present disclosure provides a laser projection device 001, which includes the light source system 000 provided by the present disclosure.

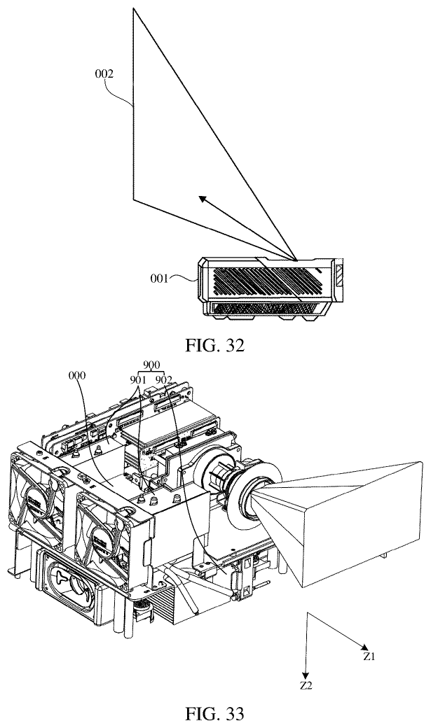

In some embodiments, referring to FIG. 32, the laser projection device 001 further includes an optical engine system and an imaging system. The light source system is used to provide a laser beam to the optical engine system. The optical engine system, which may also be referred to as the optical engine illumination system, is used to modulate the laser beam provided by the light source into an image beam and emits it to the projection lens. The projection lens is used to image the image beam and emit it to the projection screen 002. Here, the light source system may be the light source system 000 described in the above embodiments. For example, the light source system 000 may be the light source system 000 shown in FIGS. 2, 5, 9, 10, 16, 19, 20, and 21.

In some embodiments, referring to FIG. 33, the laser projection device 001 may include a heat dissipation device 900 connected to the light source system 000. Referring to FIG. 15, the light source system 000 includes a housing 100 and a laser device 200. The housing 100 is provided with a light-transmitting hole T, and the laser device 200 in the light source system 000 can be connected to the housing 100 outside the housing 100, with the light-output surface P of the laser device 200 facing the light-transmitting hole T of the housing 100. Thus, the laser device 200 can provide a laser beam to the light source system 000 through the light-transmitting hole T.

In some embodiments, referring to FIG. 11 or FIG. 17, the laser device 200 may include a substrate 205 and light-emitting units (e.g., a first-type light-emitting unit 203, a second-type light-emitting unit 204) disposed on one side of the substrate 205. The light-emitting units are used to emit laser beams, and the side of substrate 205 where the light-emitting units are arranged can serve as the light-output surface P of laser device 200. Here, the light source system 000 may further include a first circuit board 1300. The first circuit board 1300 is electrically connected to the laser device 200 and provides power to the laser device 200.

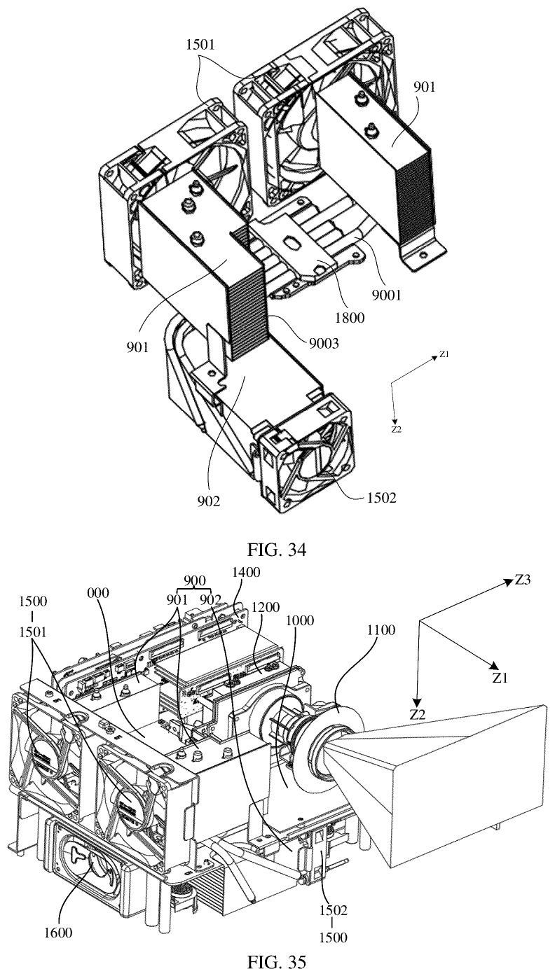

To ensure that the laser projection device 001 has a high brightness, the number of the laser devices 200 is typically at least two. However, each laser device 200 generates heat when emitting light, resulting in a high operating temperature of the light source system 000 during operation of the laser projection device 001. To ensure that the light source system 000 can operate normally, the heat dissipation device 900 connected to the light source system 000 is required to dissipate heat from the light source system 000. To better illustrate the structure of the heat dissipation device 900 and its spatial relationship with the light source system 000, referring to FIGS. 33 and 34. The heat dissipation device 900 in the laser projection device 001 may include at least one first heat dissipation component 901 and at least one second heat dissipation component 902. At least one first heat dissipation component 901 is distributed on at least one side of the light source system 000 along the first direction Z1, and the second heat dissipation component 902 is distributed on one side of the first heat dissipation component 901 along the second direction Z2. The first direction Z1 may intersect with the second direction Z2. For example, the first direction Z1 may be the direction in which the laser projection device 001 projects the image, and the second direction Z2 may be the thickness direction of the laser projection device 001. In this way, the first heat dissipation component 901 and the second heat dissipation component 902 in the heat dissipation device 900 can simultaneously dissipate heat from the light source system 000, enabling the heat generated during operation of the light source system 000 to be promptly dissipated. This ensures that the operating temperature of the light source system 000 remains in normal levels, thereby extending the service life of the light source system 000.

In some embodiments, the number of first heat dissipation assemblies 901 may be two, and the two first heat dissipation assemblies 901 may be distributed on both sides of the light source system 000 along the first direction Z1. The number of second heat dissipation assemblies 902 may be one, and the second heat dissipation component 902 may be distributed on one side of the first heat dissipation component 901 along the second direction Z2. In this way, the internal space of the laser projection device 001 can be fully utilized, such that the heat dissipation device 900 can not only meet the heat dissipation requirements of the light source system 000, but also ensure that the laser projection device 001 has a small volume.

In some embodiments, the first heat dissipation assemblies 901 and the second heat dissipation component 902 may be distributed on different sides of the light source system 000. This not only improves the heat dissipation efficiency of the heat dissipation device 900, but also further utilizes the space inside the laser projection device 001, resulting in a smaller volume of the laser projection device 001.

Referring to FIG. 35, the laser projection device 001 may further include a support plate 1000. The light source system 000 and the first heat dissipation component 901 in the laser projection device may both be disposed on one side of the support plate 1000, and the second heat dissipation component 902 may be disposed on the other side of the support plate 1000.

The light-transmitting hole T on the housing 100 of the light source system 000 may be disposed on the side of the housing 100 close to the support plate 1000. In this way, both the light source system 000 and the first heat dissipation component 901 can be connected to the support plate 1000, thereby being stably placed in the laser projection device 001. As a result, the distribution of various devices in the laser projection device can be relatively compact, which in turn allows full utilization of the space inside the laser projection device and reduces the volume of the laser projection device.

In some embodiments, the support plate 1000 may be made of a material with good thermal conductivity, such as a metal. Since the second heat dissipation component 902 is provided on the other side of the support plate 1000, the heat generated during the operation of the light source system 000 can be transferred to the support plate 1000, and then further transferred by the support plate to the second heat dissipation component 902 for heat dissipation. In addition, due to the large area of the support plate 1000, it can transfer the heat from the light source system 000 to the second heat dissipation component 902 more evenly. This can further improve the heat dissipation efficiency of the second heat dissipation component 902 in dissipating heat from the light source system 000.

In some embodiments, referring to FIG. 35, the laser projection device may further include a projection lens 1100, an optical engine system 1200, and a second circuit board 1400 that are disposed on one side of the support plate 1000. Here, the optical engine system 1200 may be used to receive the laser beam provided by the light source system 000, modulate the received laser beam to obtain a modulated beam, and then emit the modulated beam to the projection lens 1100. The projection lens 1100 may receive the modulated beam from the optical engine system 1200 and project the modulated beam to obtain a projection image. The second circuit board 1400 may be used to supply power to the operating components in the laser projection device.

In this case, the projection lens 1100 may be arranged on one side of the light source system 000 along the third direction Z3, the optical engine system 1200 may be arranged on one side of the projection lens 1100 along the first direction Z1, and the second circuit board 1400 may be disposed on the side of the optical engine system 1200 away from the projection lens 1100 along the first direction Z1. Here, the third direction Z3 may intersect with the first direction Z1 and also with the second direction Z2. This further utilizes the space inside the laser projection device 001, resulting in a smaller volume for the laser projection device 001.

In some embodiments, the projection lens 1100, the optical engine system 1200, and the second circuit board 1400 may all be arranged on the same side of the support plate 1000 as the light source system 000, and may be distributed in the remaining space on the support plate 1000 excluding the light source system 000 and the first heat dissipation component 901. In this way, the distribution of the light source system 000, the projection lens 1100, the optical engine system 1200, and the second circuit board 1400 on one side of the support plate 1000 can be relatively compact, such that the space occupied by the light source system 000, the projection lens 1100, the optical engine system 1200, and the second circuit board 1400 in the laser projection device is small, which in turn can reduce the volume of the laser projection device.

In some embodiments, referring to FIG. 35, the laser projection device 001 may further include at least one first cooling fan 1501 disposed on one side of the support plate 1000, and at least one second cooling fan 1502 disposed on the other side of the support plate 1000. Here, at least one first cooling fan 1501 may be in one-to-one correspondence with at least one first heat dissipation component 901, and at least one second cooling fan 1502 may be in one-to-one correspondence with at least one second heat dissipation component 902.

The first cooling fan 1501 may be disposed on the side of the corresponding first heat dissipation component 901 away from the projection lens 1100 in the third direction Z3, the second cooling fan 1502 may be disposed between the second heat dissipation component 902 and the projection lens 1100 in the third direction Z3, and the flow direction of the airflow generated by the first cooling fan 1501 may be the same as the flow direction of the airflow generated by the second cooling fan. Since the first cooling fan 1501 corresponds to the first heat dissipation component 901 and the second cooling fan 1502 corresponds to the second heat dissipation component 902, the first cooling fan 1501 may be arranged on the same side as the first heat dissipation component 901 and may be distributed in the remaining space on the side of the support plate 1000 where the light source system 000 is located. The second cooling fan 1502 may be arranged on the same side as the second heat dissipation component 902 and may be distributed in the remaining space on the side of the support plate 1000 where the second heat dissipation component 902 is located.

The first cooling fan 1501 and the second cooling fan 1502 fully utilize the space in the laser projection device 001 without affecting the installation of other components in the laser projection device 001. This not only meets the heat dissipation requirements of the light source system 000, but also ensures that the laser projection device 001 has a small volume.

In the present disclosure, to better illustrate the positional relationship between the cooling fans and the heat dissipation components, referring to FIG. 35, the air outlet surface of the first cooling fan 1501 may face the corresponding first heat dissipation component 901, and the air suction surface of the second cooling fan 1502 may face the corresponding second heat dissipation component 902. In this way, when the first cooling fan 1501 is in operation, since the air outlet surface of the first cooling fan 1501 may face the corresponding first heat dissipation component 901, the first cooling fan 1501 may cool the first heat dissipation component 901 through airflow, thereby improving the heat dissipation efficiency of the heat dissipation device 900. When the second cooling fan 1502 is in operation, since the air suction surface of the second cooling fan 1502 may face the corresponding second heat dissipation component 902, the second cooling fan 1502 may cool the second heat dissipation component 902 through airflow, thereby further improving the heat dissipation efficiency of the heat dissipation device 900.

In some embodiments, to illustrate with the cooperation mode between the first cooling fan 1501 and the first heat dissipation component 901: when the operating temperature of the light source system 000 in the laser projection device 001 is relatively high, the laser projection device 001 may drive the first cooling fan 1501 to work. The first cooling fan 1501 may draw in air with a lower temperature from outside the laser projection device 001 and blow the air toward the first heat dissipation component 901 through its air outlet surface. Since the air temperature outside the laser projection device 001 is lower, the air blown toward the first heat dissipation component 901 may absorb heat from the first heat dissipation component 901, thereby improving the heat dissipation efficiency of the heat dissipation device 900.

It should be noted that since the flow direction of the airflow generated by the first cooling fan 1501 may be the same as the flow direction of the airflow generated by the second cooling fan, both the first cooling fan 1501 and the second cooling fan 1502 may draw in cooler air from one side of the laser projection device. After absorbing heat and becoming warmer air, the cooler air may be guided by both the first cooling fan 1501 and the second cooling fan 1502 to the other side of the laser projection device. In this way, it is possible to avoid the undesirable situation where the first cooling fan 1501 and/or the second cooling fan 1502 blow hot air toward the heat dissipation device when they are in operation.

In some embodiments, when the area of the air outlet surface of the first cooling fan 1501 is large, that is, when the diameter of the air outlet surface of the first cooling fan 1501 is greater than the width of the first heat dissipation component 901, a portion of the air outlet surface of the first cooling fan 1501 may face the upper space of the light source system 000. In this way, when the first cooling fan 1501 is in operation, the air it draws in can not only absorb the heat from the first heat dissipation component 901 but also absorb the heat generated by the operation of the light source system 000, thereby further improving the heat dissipation efficiency of the heat dissipation device 900 in dissipating heat from the light source system 000.

In some embodiments, referring to FIG. 35, the laser projection device 001 may further include a functional component 1600 disposed on the other side of the support plate 1000. For example, the functional component 1600 may be arranged on the same side as the second heat dissipation component 902, and the functional component 1600 may be used to ensure that the laser projection device 001 can perform its corresponding functions. The functional component 1600 may be at least one of a speaker, a counterweight, and a storage battery. For example, when the functional component 1600 is a speaker, the laser projection device 001 may have the function of emitting sound to the outside environment.

In some embodiments, as shown in FIG. 35, the second heat dissipation component 902 may be arranged adjacent to the functional component 1600 in the third direction Z3, and the second cooling fan 1502 may be disposed between the second heat dissipation component 902 and the projection lens 1100 in the third direction Z3. In this way, the space inside the laser projection device 001 can be further utilized, enabling a more compact arrangement of the various operating components within the laser projection device 001, thereby ensuring that the laser projection device 001 has a small volume.

In some embodiments, when the functional component 1600 is a speaker or a storage battery, the second heat dissipation component 902 may be disposed on the side adjacent to the functional component 1600 within the laser projection device 001. Since the second heat dissipation component 902 may be arranged adjacent to the functional component 1600 along the third direction Z3, the side of the second heat dissipation component 902 away from the second cooling fan 1502301 can be in contact with the functional component 1600. In this way, the second heat dissipation component 902 not only provides effective heat dissipation for the light source system 000 but also provides heat dissipation for the functional component 1600.

It should be noted that, in the third direction Z3, the first cooling fan 1501 is disposed on the side of the first heat dissipation component 901 away from the projection lens 1100, and the air outlet surface of the first cooling fan 1501 faces the first heat dissipation component 901. Therefore, when the first cooling fan 1501 dissipates heat from the light source system 000 and the first heat dissipation component 901 through airflow, the airflow, after absorbing heat from the first heat dissipation component 901, reaches the projection lens 1100, which may cause the operating temperature of the projection lens 1100 to rise. In addition, in the third direction Z3, the second cooling fan 1502 is disposed between the second heat dissipation component 902 and the projection lens 1100, with its air suction surface of the second cooling fan 1502 facing the second heat dissipation component 902. Moreover, a support plate 1000 is also disposed between the second cooling fan 1502 and the projection lens 1100. Therefore, when the second cooling fan 1502 dissipates heat from the second heat dissipation component 902, the airflow, after absorbing heat from the second heat dissipation component 902, is blocked by the support plate 1000 and does not reach the projection lens 1100. As a result, when the heat generated by the light source system 000 is dissipated by both the first heat dissipation component 901 and the second heat dissipation component 902 simultaneously, it not only improves the heat dissipation efficiency for the light source system 000 but also prevents the undesirable phenomenon of a significant temperature rise in the projection lens 1100 during operation.

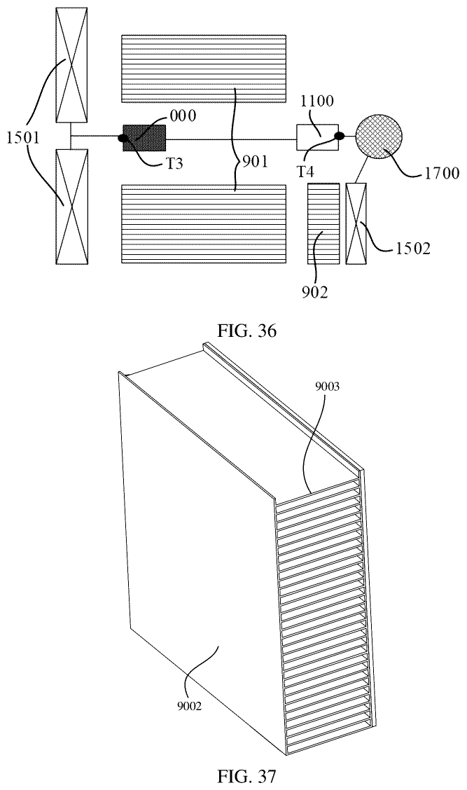

In some embodiments, referring to FIG. 36, the laser projection device 001 may further include a first temperature sensor T3 and a control component 1700. The first temperature sensor T3 in the laser projection device 001 may be attached to the light source system 000, for example, the first temperature sensor T3 may be attached to the side of the laser device 200 away from the light-output surface P in the light source system 000. The control component 1700 in the laser projection device 001 may be electrically connected to the first temperature sensor T3, the first cooling fan 1501, and the second cooling fan 1502. Here, since the first temperature sensor T3 can be attached to the light source system 000, the first temperature sensor T3 can detect the operating temperature of the light source system 000. Furthermore, since the control component 1700 can be connected to the first temperature sensor T3, the first temperature sensor T3 can transmit the detected temperature to the control component 1700.

The control component 1700 may be configured to: based on the operating temperature of the light source system 000 detected by the first temperature sensor T3, control the operating state of the first cooling fan 1501 and/or the second cooling fan 1502. Here, the first cooling fan 1501 and the second cooling fan 1502 can have two operating states: an on state and an off state. When the first cooling fan 1501 and the second cooling fan 1502 are in the on state, the first cooling fan 1501 and the second cooling fan 1502 can draw air from the external environment into the laser projection device 001; when the first cooling fan 1501 and the second cooling fan 1502 are in the off state, the first cooling fan 1501 and the second cooling fan 1502 stop working. In this way, the laser projection device 001 can more accurately control the first cooling fan 1501 and/or the second cooling fan 1502 to be in the on or off state through the control component 1700, thereby reducing the power consumption of the laser projection device 001 during operation.

In some embodiments, the control component 1700 may be configured such that: when the operating temperature of the light source system 000 is within the first temperature range, one of the first cooling fan 1501 and the second cooling fan 1502 is turned on; when the operating temperature of the light source system 000 is within the second temperature range, both the first cooling fan 1501 and the second cooling fan 1502 are turned on simultaneously. In this way, the laser projection device 001 can more accurately control the working status of each cooling fan through the control component 1700. The lower limit value of the second temperature range is greater than the upper limit value of the first temperature range. For example, the first temperature range may be (40, 50], and the second temperature range may be (50, 60). Here, the temperature units within both the first temperature range and the second temperature range may be degrees Celsius.

In some embodiments, referring to FIG. 36, the control component 1700 may further include a second temperature sensor T4 attached to the projection lens 1100, with the second temperature sensor T4 electrically connected to the control component 1700. Here, since the second temperature sensor T4 may be attached to the projection lens 1100, the second temperature sensor T4 can detect the operating temperature of the projection lens 1100. Furthermore, since the control component 1700 is electrically connected to the second temperature sensor T4, the second temperature sensor T4 may transmit the detected operating temperature of the projection lens 1100 to the control component 1700.

The control component 1700 may be configured such that, upon detecting that the operating temperature of the projection lens 1100 exceeds a specified temperature through the second temperature sensor T4, the first cooling fan 1501 is turned off and the second cooling fan 1502 is turned on.

In some embodiments, the first cooling fan 1501 is disposed on the side of the first heat dissipation component 901 away from the projection lens 1100 in the third direction Z3, and the air outlet surface of the first cooling fan 1501 faces the first heat dissipation component 901. Therefore, when the first heat dissipation component 901 dissipates heat from the laser device 200 through the airflow generated by the first cooling fan 1501, the higher-temperature airflow is blown toward the region where the projection lens 1100 is located, thereby causing the operating temperature of the projection lens 1100 to rise. When the control component 1700 detects that the operating temperature of the projection lens 1100 exceeds a specified temperature through the second temperature sensor T4, it can turn off the first cooling fan 1501 and turn on the second cooling fan 1502. In this way, the second cooling fan 1502 can continue to dissipate heat from the laser device 200 while ensuring that the operating temperature of the projection lens 1100 remains low.

In some embodiments, the control component 1700 may also be electrically connected to the laser device 200 in the light source system 000. The control component 1700 may also be configured to adjust the operating current of the laser device 200 after determining that the operating temperature of the laser device 200 is outside the second temperature range. In this way, the laser projection device 001 can protect the laser device 200 through the control component 1700, preventing damage to the laser device 200 due to excessive operating temperature.

In some embodiments, after determining that the operating temperature detected by the first temperature sensor T3 is below the first temperature range, the control component 1700 may increase the operating current of the laser device 200 to enhance the brightness of the laser beam provided by the laser device 200; and after determining that the temperature detected by the first temperature sensor T3 is above the second temperature range, the control component 1700 may reduce the operating current of the laser device 200 to ensure that the operating temperature of the laser device 200 remains stable within the first temperature range or the second temperature range.

In related art, when the ambient temperature of the environment where the laser projection device 001 is located is too high, the heat dissipation capacity of the heat dissipation device 900 in the laser projection device 001 decreases, In this case, to transfer the heat generated by the light source system 000 to the external environment through the heat dissipation device 900, it is necessary to increase the rotation speed of the first cooling fan 1501 and/or the second cooling fan 1502 to improve the heat dissipation capability of the heat dissipation device 900. However, this will cause the first cooling fan 1501 and/or the second cooling fan 1502 to generate relatively large noise, which in turn leads to increased operating noise of the laser projection device 001. Furthermore, if the ambient temperature of the environment where the laser projection device 001 is located continues to rise, simply increasing the rotation speed of the first cooling fan 1501 and/or the second cooling fan 1502 will not be able to effectively cool the light source system 000, which will further affect the light efficiency, reliability, and service life of the light source system 000.

In the present disclosure, the first temperature sensor T3 is installed at the light source system 000 of the laser projection device 001 to detect the operating temperature of the light source system 000. Through the control unit 1700, once it is determined that the ambient temperature exceeds the second temperature range, the operating current of the laser device 200 in the light source system 000 is reduced, thereby decreasing the heat generated by the laser device 200 and lowering the operating temperature of the light source system 000. As a result, since the heat generated by the laser device 200 is reduced, there is no need to increase the rotational speed of the first cooling fan 1501 to lower the operating temperature of the light source system 000. This reduces the operating noise of the laser projection device 001 and improves the light efficiency, reliability, and service life of the light source system 000, resulting in a better display effect of the image projected by the laser projection device 001.

In some embodiments, referring to FIGS. 34 and 37, the heat dissipation component may be the first heat dissipation component 901 or the second heat dissipation component 902. Each of the first heat dissipation component 901 and the second heat dissipation component 902 may include a heat pipe 9001, an encapsulation plate 9002, and a plurality of heat dissipation fins 9003 arranged in an array.

One end of the heat pipe 9001 in the heat dissipation component may be connected to the side of the laser device 200 away from the light-output surface P in the light source system 000, and the other end of the heat pipe 9001 may be sequentially connected to the plurality of heat dissipation fins 9003. For example, each heat dissipation fin 9003 in the heat dissipation component may be provided with a through slot, and one end of the heat pipe 9001 may sequentially pass through each through slot to be sequentially connected to the plurality of heat dissipation fins 9003. Thus, when the laser projection device 001 is operating and the light source system 000 is in an operational state, the laser device 200 in the light source system 000 generates a large amount of heat, and the heat pipe 9001 can absorb the heat generated by the laser device 200 during operation. Since the heat pipe 9001 can be sequentially connected to the plurality of heat dissipation fins 9003, the heat pipe 9001 can effectively transfer this heat to each heat dissipation fin 9003, which then dissipates the heat to reduce the operating temperature of the laser device 200.

The side surfaces of at least some of the heat dissipation fins 9003 in the heat dissipation component may be fixedly connected to the end faces of the encapsulation plate 9002. For example, the sides of all heat dissipation fins 9003 in the heat dissipation component may be fixedly connected to the end face of the encapsulation plate 9002, ensuring that the heat dissipation fins 9003 do not generate noise due to vibration when the laser projection device 001 is operating, thereby reducing the operational noise of the laser projection device 001.

In some embodiments, during the operation of the laser projection device 001, various components inside the laser projection device 001, such as the fluorescent wheel, the laser device 200, and the focusing motor, are in an operating state and generate vibrations. Since the thickness of the heat dissipation fins 9003 is generally small, they are prone to resonate with the various operating components inside the laser projection device 001, which in turn produces relatively large noise. In the present disclosure, since the side surfaces of at least some of the heat dissipation fins 9003 in the plurality of heat dissipation fins 9003 can be fixedly connected to the end faces of the encapsulation plate 9002, the encapsulation plate 9002 can exert a good restraining effect on the heat dissipation fins 9003. This reduces the vibration amplitude of the heat dissipation fins 9003, thereby ensuring that the heat dissipation fins 9003 will not generate noise due to vibration when the laser projection device 001 is in operation.

In some embodiments, referring to FIG. 38, in each heat dissipation component, the number of encapsulation plates 9002 is at least two. The plurality of heat dissipation fins 9003 are distributed between two oppositely arranged encapsulation plates 9002, and the two opposite side surfaces of each heat dissipation fin 9003 are respectively fixedly connected to the end surfaces of the two oppositely arranged encapsulation plates 9002. Since the two oppositely arranged encapsulation plates 9002 can respectively constrain the two opposite side surfaces of each heat dissipation fin 9003, the vibration of the heat dissipation fins 9003 can be further reduced through the encapsulation plates 9002, thereby further reducing the noise generated by the laser projection device 001 during operation.

Here, since the heat dissipation fins 9003 may have various shapes, there are multiple possible implementations for using the encapsulation plates 9002 to constrain the two opposite side surfaces of the heat dissipation fins 9003:

In some embodiments, as shown in FIG. 38, the heat dissipation fins 9003 are rectangular in shape. The two opposite side surfaces of each heat dissipation fin 9003 can be fixedly connected to the end surfaces of the two oppositely arranged encapsulation plates 9002 by welding. In this way, it can be ensured that the two encapsulation plates 9002 can exert a good restraining effect on the heat dissipation fins 9003.

In other embodiments, as shown in FIG. 38, the heat dissipation fin 9003 may include a first portion 9003a and a second portion 9003b. The shapes of the first portion 9003a and the second portion 9003b are both rectangular, and the width of the first portion 9003a is greater than the width of the second portion 9003b. Here, one side of the first part 9003a of the same heat dissipation fin 9003 can be flush with one side of the second part 9003b. In this case, the heat dissipation component includes three encapsulation plates 9002, namely: a first encapsulation plate 9002a, a second encapsulation plate 9002b, and a third encapsulation plate 9002c. The heights of the three encapsulation plates 9002 may be equal, and the width of the first encapsulation plate 9002a may equal the sum of the widths of the second encapsulation plate 9002b and the third encapsulation plate 9002c. For this purpose, the first encapsulation plate 9002a may be arranged opposite either the second encapsulation plate 9002b or the third encapsulation plate 9002c. In this way, in the heat dissipation component, the two opposite side surfaces of the first portion 9003a of each heat dissipation fin 9003 can be fixedly connected to the end face of the first encapsulation plate 9002a and the end face of the second encapsulation plate 9002b, respectively. The two opposite side surfaces of the second portion 9003b in each heat dissipation fin 9003 can be fixedly connected to the end face of the first encapsulation plate 9002a and the end face of the third encapsulation plate 9002c, respectively.

In some embodiments, referring to FIG. 35, the laser projection device 001 may further include a cooling fan 1500 corresponding to each heat dissipation component, with the air outlet surface of the cooling fan 1500 facing the side surface of the heat dissipation fins 9003 of the corresponding heat dissipation component that is not connected to the encapsulation plate 9002. Thus, when the cooling fan 1500 is in operation, since the air outlet surface of each cooling fan 1500 faces the side of the heat dissipation fins 9003 of the corresponding heat dissipation component that is not connected to the encapsulation plate 9002, the cooling fan 1500 can form an airflow channel in the gap between each heat dissipation fin 9003 and cool the heat dissipation fins 9003 through airflow, thereby further improving the heat dissipation efficiency of the heat dissipation device 900.

In some embodiments, as shown in FIG. 34, the air outlet surface of the first cooling fan 1501 may face the side surface of the heat dissipation fins 9003 of the first heat dissipation component 901 that is not connected to the encapsulation plate 9002, and the air outlet surface of the second cooling fan 1502 may face the side surface of the heat dissipation fins 9003 of the second heat dissipation component 902 that is not connected to the encapsulation plate 9002.

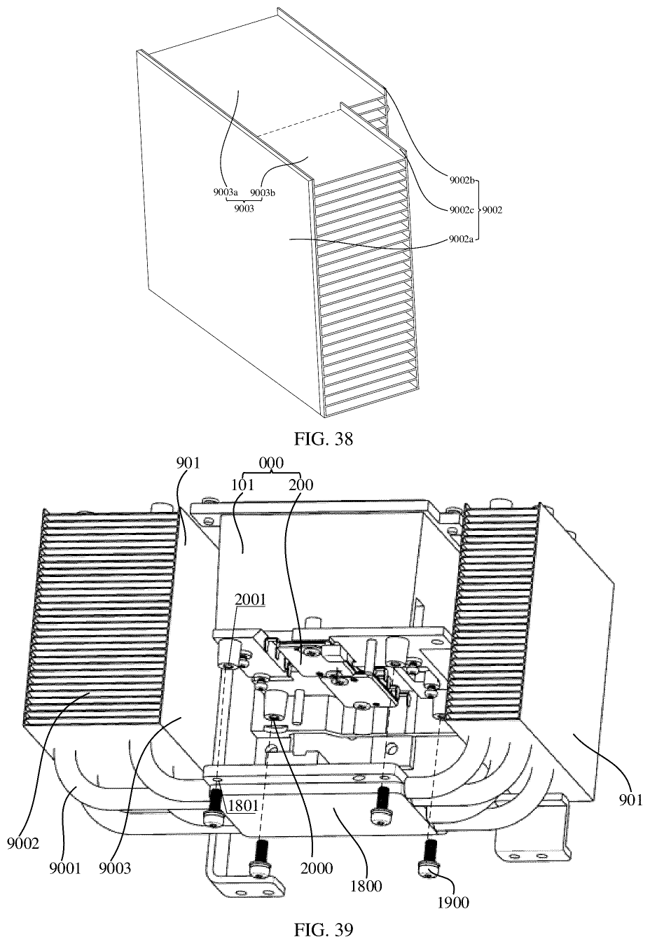

In some embodiments, referring to FIGS. 34 and 39, the laser projection device 001 may further include a heat conduction plate 1800 attached to the side of the laser device 200 away from the light-emitting surface P, one end of the heat pipe 9001 in each heat dissipation component may be connected to the heat conduction plate 1800, and the heat conduction plate 1800 may be disposed between the laser device 200 and the support plate 1000. In this way, the internal space of the laser projection device can be fully utilized, resulting in a smaller volume for the laser projection device 001.

For example, the heat conduction plate 1800 may be attached to the side of the laser device 200 away from the light-emitting surface P using thermal adhesive. The heat generated by the laser device 200 can be transferred to the heat conduction plate 1800, then from the heat conduction plate 1800 to the heat pipe 9001, and finally from the heat pipe 9001 to the heat dissipation fins 9003. This allows the heat generated by the operation of the laser device 200 to be more uniformly transferred to the heat pipe 9001, thereby improving the heat dissipation efficiency of the heat dissipation device 900.

In some embodiments, referring to FIG. 39, the light source system 000 may further include a plurality of connecting members 1900. The heat conduction plate 1800 is provided with a plurality of first mounting holes 1801, and the laser device 200 is provided with a plurality of connecting columns 2000. The connecting columns 2000 are provided with second mounting holes 2001 corresponding to the first mounting holes 1801 of the heat conduction plate 1800. The operator can pass the connecting member 1900 through the first mounting hole 1801 of the heat conduction plate 1800 and then insert it into the second mounting hole 2001 of the connecting column 2000, such that the heat conduction plate 1800 is closely attached to the laser device 200.

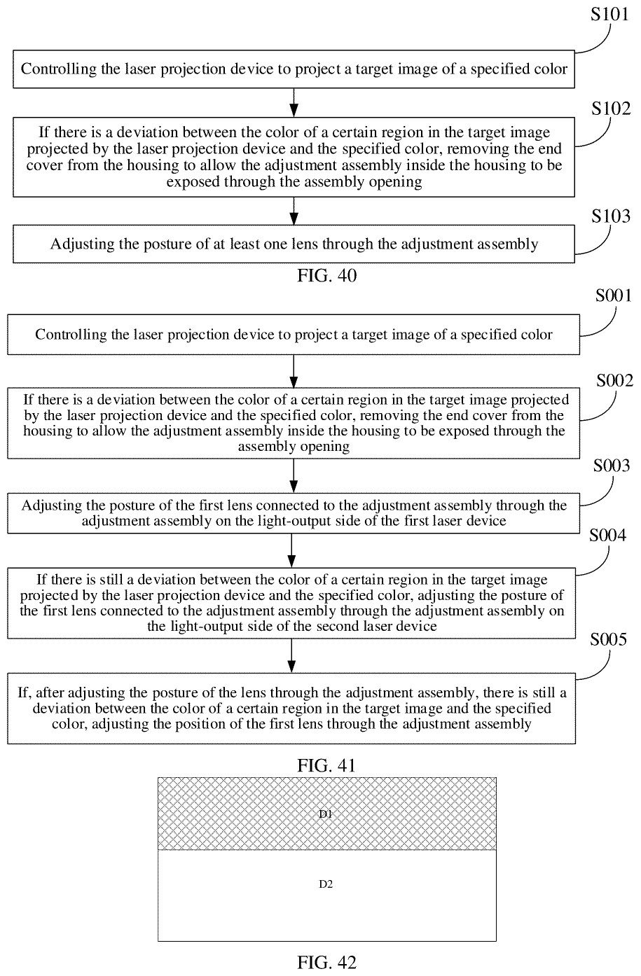

On the other hand, the present disclosure provides a method for adjusting a light source system 000. Optionally, the light source system 000 may be as shown in FIGS. 2, 5, 9, 10, 16, 19, 20, 21, etc. In some embodiments, referring to FIG. 40, the method for adjusting the light source system 000 may be applied in the debugging process of a laser projection device. The method for adjusting the light source system 000 may include the following steps.

In step S101, the laser projection device is controlled to project a target image of a specified color.

Here, the operator can control the laser projection device to project a test card of a specified color onto the projection screen, enabling the projection screen to display a target image of the specified color. For example, the test card of the specified color may be a white test card, and the projection screen can subsequently display a white target image.

In step S102, if there is a deviation between the color of a certain region in the target image projected by the laser projection device and the specified color, the end cover is removed from the housing to allow the adjustment assembly inside the housing to be exposed through the assembly opening.

In step S103, the posture of at least one lens is adjusted through the adjustment assembly.

In the present disclosure, since at least one of the plurality of lenses 400 in the light source system 000 may be connected to the housing 100 of the light source system 000 through the adjustment assembly 300, the operator can adjust the posture of the lens 400 by adjusting the posture of the adjustment assembly 300. When there is a deviation between the color of a certain region in the projection image projected by the projection lens and the specified color, the operator can efficiently adjust the posture of the lens 400 by adjusting the posture of the adjustment assembly 300, ensuring that the colors of all regions in the target image projected by the laser projection device are consistent with the target color. Moreover, when adjusting the posture of the lens 400, there is no need to reinstall the lens 400 to adjust its posture. In this way, the efficiency and accuracy of adjusting the posture of the lens 400 can be improved, thereby increasing the factory efficiency of the laser projection device.

Referring to FIG. 41, the present disclosure also provides a method for adjusting a light source system 000. The method includes the following steps.

In step S001, the laser projection device is controlled to project a target image of a specified color. For example, the operator can control the laser projection device to project a test card of the specified color onto the projection screen and observe the target image to determine whether there are any deviations between the various regions of the target image projected by the laser projection device and the specified color. Here, the test card of the specified color may be a white test card, and the projection screen can subsequently display a white target image.

If there is no deviation between the color of a certain region in the target image projected by the laser projection device and the specified color, i.e., the projection image projected by the laser projection device meets the requirements, there is no need to adjust the light source system 000 in the laser projection device. If there is a deviation between the color of a certain region in the target image projected by the laser projection device and the specified color, it is necessary to adjust the light source system 000 in the laser projection device. In this case, the following step S002 can be executed.

In step S002, if there is a deviation between the color of a certain region in the target image projected by the laser projection device and the specified color, the end cover is removed from the housing to allow the adjustment assembly inside the housing to be exposed through the assembly opening.

In some embodiments, the operator can remove the end cover from the housing to allow the adjustment assembly inside the housing to be exposed through the assembly opening.

In step S003, the posture of the first lens connected to the adjustment assembly is adjusted through the adjustment assembly on the light-output side of the first laser device.

In some embodiments, the operator can adjust the posture of the first lens connected to the adjustment assembly through the adjustment assembly on the light-output side of the first laser device.

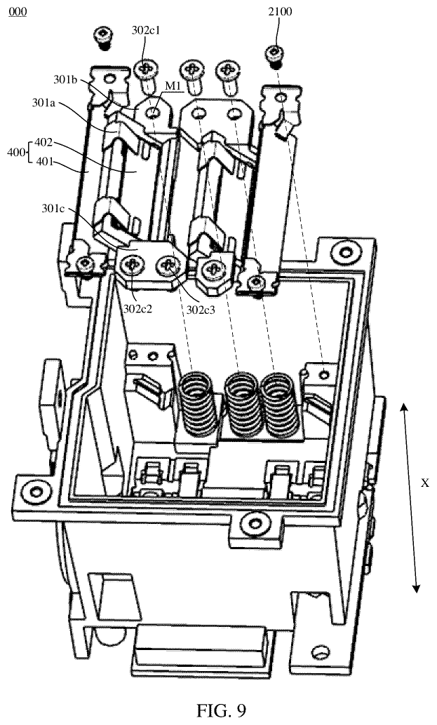

As shown in FIGS. 6 and 9, the operator can adjust the posture of the first lens 401 connected to the adjustment assembly 300 through the adjustment assembly 300 on the light-output side of the first laser device 200a based on the color cast situation in the target image, thereby adjusting the positions of the blue laser beam and green laser beam in the target image to ensure that the colors of the target image are consistent with the specified colors. In this way, the operator only needs to adjust the first lens 401 to resolve the color cast problem in the target image.

In some embodiments, adjusting the posture of the first lens through the adjustment assembly may include:

Controlling at least one adjustment member in the adjustment assembly to move along the first target direction, thereby adjusting the posture of the first lens carried by the bracket in the adjustment assembly. Here, the first target direction is parallel to the light-output direction of the laser device.

In some embodiments, the operator can control at least one adjustment member in the control adjustment assembly to move along the first target direction, thereby adjusting the posture of the first lens carried by the bracket in the adjustment assembly.

As shown in FIGS. 6 and 9, when it is necessary to adjust the posture of the first lens 401, the operator can control the adjustment member 302 in the adjustment assembly 300 to move along the first target direction X1, thereby causing the bracket 301 in the adjustment assembly 300 to move along the first target direction X1 on one or more sides through the adjustment member 302, resulting in a change in the posture of the bracket 301, thereby achieving adjustment of the posture of the first lens 401.

The control of the adjustment member 302 to move in the target direction may include: controlling the screwing depth of the adjusting screw in the threaded hole to control the movement of the adjusting screw in the target direction.

In some embodiments, the operator can control the screwing depth of the adjusting screw in the threaded hole to control the movement of the adjusting screw along the target direction.

As shown in FIGS. 6 and 9, during the installation of the light source system 000, the operator can fix the bracket 301 in the light source system 000 by engaging the adjusting screw 302c in the adjustment assembly 302 through threaded engagement, In this case, the adjusting screw 302c can apply a clamping force to the bracket 301, causing the bracket 301 to apply a clamping force to the elastic element 302b in the adjustment assembly 302, thereby compressing the elastic element 302b and storing elastic force. In this way, when it is necessary to adjust the posture of the first lens 401, the operator can control the adjusting screw 302c in the adjustment assembly 300 to move along the target direction X, enabling the elastic element 302b to release the elastic force and apply a pushing force along the target direction X to the bracket 301, thereby changing the posture of the bracket 301.

Thus, controlling at least one adjustment member 302 in the adjustment assembly 300 to move along the first target direction X1 to adjust the posture of the first lens 401 carried by the bracket 301 in the adjustment assembly 300 may include the following steps.

In step A-1, when the screwing depth of the first screw in the corresponding threaded hole is the same as the screwing depth of the second screw in the corresponding threaded hole, the third screw is controlled to move in the corresponding threaded hole, so as to make the carrier rotate around an axis parallel to the length direction of the lens.

In some embodiments, when the screwing depth of the first screw in the corresponding threaded hole is the same as the screwing depth of the second screw in the corresponding threaded hole, the operator can control the third screw to move in the corresponding threaded hole, causing the carrier to rotate around an axis parallel to the length direction of the lens. In the present disclosure, when there is a deviation between the color of the first region or the second region in the target image and the specified color, the operator can control the first lens to rotate around an axis parallel to the length direction of the first lens through the adjustment assembly. The first region and the second region are two regions distributed in the width direction of the target image. The first region may be located above the second region.

As shown in FIGS. 9 and 42, when the first region D1 in the target image is reddish relative to the specified color, the operator can control the third screw 302c3 to move in the corresponding threaded hole, causing the carrier 301a to rotate around an axis parallel to the length direction of the lens 400. This allows the lens 400 to shift the positions of the blue laser beam and green laser beam upward in the projection image, thereby turning the originally reddish region in the target image into the specified color. It should be noted that when the second region D2 in the target image is reddish relative to the specified color, the operator can move the third screw 302c3 in the opposite direction in the corresponding threaded hole, causing the lens 400 to shift the positions of the blue laser beam and green laser beam downward in the projection image.

In step B-1, when the screwing depth of the second screw in the corresponding threaded hole is the same as the screwing depth of the third screw in the corresponding threaded hole, the first screw is controlled to move in the corresponding threaded hole, causing the carrier to rotate around an axis perpendicular to the length direction of the lens.

In some embodiments, when the screwing depth of the second screw in the corresponding threaded hole is the same as the screwing depth of the third screw in the corresponding threaded hole, the operator can control the first screw to move in the corresponding threaded hole, causing the carrier to rotate around an axis perpendicular to the length direction of the lens.

In the present disclosure, when the color of the third region or fourth region in the target image deviates from the specified color, the operator can control the first lens to rotate around an axis perpendicular to the length direction of the first lens by controlling the adjustment assembly. The third and fourth regions are two regions distributed along the length direction of the target image. The third region may be located to the left of the fourth region.

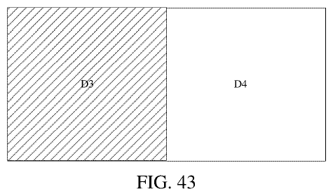

In some embodiments, as shown in FIGS. 9 and 43, when the third region D3 in the target image is yellowish relative to the specified color, the operator can control the first screw 302cl to move in the corresponding threaded hole, causing the carrier 301a to rotate around an axis perpendicular to the length direction of the lens 400. This allows the lens 400 to shift the positions of the blue laser beam and green laser beam in the projection image to the left, thus causing the region in the target image that was originally yellowish to appear as the specified color. It should be noted that when the fourth region D4 in the target image is yellowish relative to the specified color, the operator can move the third screw 302c3 in the opposite direction in the corresponding threaded hole, causing the lens 400 to shift the positions of the blue laser beam and green laser beam in the projection image to the right.

In the present disclosure, when the colors of the first or second region and the third or fourth region in the target image deviate from the specified color, the operator can control the first lens to rotate around an axis parallel to the length direction of the first lens and control the first lens to rotate around an axis perpendicular to the length direction of the first lens by controlling the adjustment assembly. Here, there is no distinction in the order of controlling the rotation of the first lens around an axis parallel to the length direction of the first lens and controlling the rotation of the first lens around an axis perpendicular to the length direction of the first lens.

An illustrative explanation is provided for the scenario where the first region D1 in the target image is reddish relative to the specified color, and the third region D3 is yellowish relative to the specified color. The operator can control the third screw 302c3 to move in the corresponding threaded hole, causing the carrier 301a to rotate around an axis parallel to the length direction of the lens 400, thereby enabling the lens 400 to shift the positions of the blue laser beam and green laser beam upward in the projection image. The operator can also control the movement of the first screw 302cl in the corresponding threaded hole to rotate the carrier 301a around an axis perpendicular to the length direction of the lens 400, enabling the lens 400 to shift the positions of the blue laser beam and green laser beam to the left in the projection image. In this way, the originally color-shifted regions in the target image are transformed into regions displaying the specified color.

In step S004, if there is still a deviation between the color of a certain region in the target image projected by the laser projection device and the specified color, the posture of the first lens connected to the adjustment assembly is adjusted through the adjustment assembly on the light-output side of the second laser device.

In some embodiments, if there is still a deviation between the color of a certain region in the target image projected by the laser projection device and the specified color, the operator can adjust the posture of the first lens 401 connected to the adjustment assembly 300 through the adjustment assembly 300 on the light-output side of the second laser device 200b.

As shown in FIGS. 6 and 9, if there is still a deviation between the color of a certain region in the target image projected by the laser projection device and the specified color, the operator can adjust the posture of the first lens 401 connected to the adjustment assembly 300 through the adjustment assembly 300 on the light-output side of the second laser device 200b, thereby further adjusting the corresponding positions of the blue laser beam and green laser beam in the target image to ensure that the color of the target image is consistent with the specified color. Here, the method by which the operator adjusts the posture of the first lens 401 connected to the adjustment assembly 300 through the adjustment assembly 300 on the light-output side of the second laser device 200b can be referenced from the method by which the operator adjusts the posture of the first lens 401 through the adjustment assembly 300 on the light-output side of the first laser device 200a, and will not be repeated here.

In step S005, if, after adjusting the posture of the lens through the adjustment assembly, there is still a deviation between the color of a certain region in the target image and the specified color, the position of the first lens is adjusted through the adjustment assembly.

In some embodiments, if there is still a deviation between the color of a certain region in the target image and the specified color after adjusting the posture of the first lens through the adjustment assembly on the light-output side of the second laser device, the operator can adjust the position of the first lens through the adjustment assembly.

Here, the operator can prioritize adjusting the position of the first lens 401 corresponding to the adjustment assembly 300 on the light-output side of the first laser device 200a. Adjusting the position of the first lens 400 through the adjustment assembly 300 may include:

Controlling each adjustment member in the adjustment assembly to move the same distance in the target direction to adjust the position of the lens carried by the bracket in the adjustment assembly.

In some embodiments, the operator can control each adjustment member in the adjustment assembly to move the same distance in the target direction to adjust the position of the lens carried by the bracket in the adjustment assembly.

As shown in FIG. 9, adjusting the position may involve moving the lens 400 along the first target direction X1. When it is necessary to adjust the position of the lens 400, the operator can control each adjustment member 302 in the adjustment assembly 300 to move the same distance in the first target direction X1, causing the first elastic element 302b1, second elastic element 302b2, and third elastic element 302b3 corresponding to the first screw 302cl, second screw 302c2, and third screw 302c3 respectively to release the same elastic force, driving the first connector 301b and second connector 301c to move synchronously in the first target direction X1. This causes the first connector 301b and second connector 301c to drive the carrier 301a to move in the first target direction X1, thereby enabling the bracket 301 to drive the lens 400 to move in the first target direction X1. In this way, the position of the lens 400 carried by the bracket 301 can be adjusted.

If there is still a deviation between the color of a certain region in the target image projected by the laser projection device 001 and the specified color, the position of the first lens 401 connected to the adjustment assembly 300 is adjusted through the adjustment assembly 300 on the light-output side of the second laser device 200b. Here, the method by which the operator adjusts the posture of the first lens 401 connected to the adjustment assembly 300 through the adjustment assembly 300 on the light-output side of the second laser device 200b can be referenced from the method by which the operator adjusts the position of the first lens 401 through the adjustment assembly 300 on the light-output side of the first laser device 200a, and will not be repeated here.

The above are only optional embodiments of the present disclosure and are not intended to limit the present disclosure. Any modifications, equivalent substitutions, improvements, etc., made within the principles of the present disclosure shall be included in the protection scope of the present disclosure.

1. A laser projection device, comprising: a light source system, an optical engine system, a projection lens, and a heat dissipation device; wherein
the light source system is adjacent to and connected to the heat dissipation device, the light source system is configured to provide a laser beam to the optical engine system, and the heat dissipation device is configured to dissipate heat from the light source system; and
the optical engine system and the projection lens are disposed on one side of the light source system and stacked along a first direction, the optical engine system is configured to modulate the laser beam provided by the light source system into an image beam and then emit the image beam to the projection lens, and the projection lens is configured to image the image beam to an image and then emit the image to a projection screen;
wherein the first direction is a direction in which the laser projection device projects a projection image.

2. The laser projection device according to claim 1, wherein the heat dissipation device comprises at least one first heat dissipation component and at least one second heat dissipation component; wherein
the at least one first heat dissipation component is arranged on at least one side of the light source system in the first direction, and the at least one second heat dissipation component is arranged on one side of the first heat dissipation component in a second direction, wherein the second direction intersects with the first direction, and the second direction is a thickness direction of the laser projection device.

3. The laser projection device according to claim 2, wherein the number of the at least one first heat dissipation component is two, and the two first heat dissipation components are respectively arranged on two sides of the light source system in the first direction; and
the number of the at least one second heat dissipation component is one, and the second heat dissipation component is arranged on one side of one of the first heat dissipation components in the second direction.

4. The laser projection device according to claim 2, further comprising a support plate; wherein
the light source system and the at least one first heat dissipation component are both disposed on one side of the support plate and connected to the support plate, and the at least one second heat dissipation component is arranged on another side of the support plate; and
the optical engine system and the projection lens are both disposed on one side of the support plate, and the projection lens is disposed on one side of the light source system in a third direction, wherein the third direction intersects with both the first direction and the second direction.

5. The laser projection device according to claim 4, further comprising a second circuit board;
wherein the second circuit board, the optical engine system, and the projection lens are all disposed on one side of the support plate, and the second circuit board is configured to supply power to working devices of the laser projection device.

6. The laser projection device according to claim 5, wherein the optical engine system is arranged on one side of the projection lens in the first direction, and the second circuit board is disposed on one side of the optical engine system away from the projection lens in the first direction.

7. The laser projection device according to claim 5, wherein the projection lens, the optical engine system, and the second circuit board are all arranged on the support plate on the same side as the light source system, and are arranged in a remaining space on the support plate excluding the light source system and the at least one first heat dissipation component.

8. The laser projection device according to claim 4, further comprising at least one first cooling fan and at least one second cooling fan;
wherein the at least one first cooling fan is disposed on one side of the support plate, the at least one second cooling fan is disposed on another side of the support plate, the at least one first cooling fan is in one-to-one correspondence with the at least one first heat dissipation component, and the at least one second cooling fan is in one-to-one correspondence with the at least one second heat dissipation component.

9. The laser projection device according to claim 8, further comprising a functional component;
wherein the functional component is disposed on the same side of the support plate as the at least one second heat dissipation component, and the functional component is configured to ensure that the laser projection device achieves a corresponding function, wherein the functional component comprises at least one of a speaker, a counterweight, or a storage battery.

10. The laser projection device according to claim 9, wherein the at least one second heat dissipation component is adjacent to the functional component in the third direction, and the at least one second cooling fan is disposed between the at least one second heat dissipation component and the projection lens in the third direction.

11. The laser projection device according to claim 1, wherein the light source system comprises a housing and a laser device; wherein
the housing is provided with a light-transmitting hole, and the laser device is connected to an outside of the housing, with a light-output surface of the laser device facing the light-transmitting hole.

12. The laser projection device according to claim 11, wherein the light source system further comprises a first circuit board, wherein the first circuit board is disposed on one side of the laser device and is electrically connected to the laser device for powering the laser device.

13. The laser projection device according to claim 11, wherein the light source system further comprises a polarization conversion component and a plurality of lenses, wherein the polarization conversion component is disposed between the laser device and at least one of the plurality of lenses, and is configured to convert an incident laser beam and then direct the laser beam as converted to the lens.

14. The laser projection device according to claim 11, wherein the light source system further comprises a polarization conversion component, a light homogenizing assembly, and a plurality of lenses; and
the number of laser devices is two, and each of the two laser devices comprises at least one row of first-type light-emitting units for emitting a first-type laser beam, and at least one row of second-type light-emitting units for emitting a second-type laser beam; wherein
the plurality of lenses comprises a light-combining lens group, wherein the light-combining lens group is disposed on light-output sides of the two laser devices, and the light-combining lens group is configured to direct laser beams emitted by the two laser devices to the light homogenizing assembly; and
the polarization conversion component is disposed between the light-combining lens group and at least one of the laser devices, the polarization conversion component is configured to adjust a polarization mode of a laser beam emitted by at least one of the laser devices, such that a polarization mode of a first-type laser beam emitted by one laser device is different from a polarization mode of a first-type laser beam emitted by another laser device, and a polarization mode of a second-type laser beam emitted by one laser device is different from a polarization mode of a second-type laser beam emitted by another laser device.

15. The laser projection device according to claim 14, wherein the polarization conversion component comprises a first polarization conversion lens and a second polarization conversion lens; wherein
the first polarization conversion lens covers at least a portion of the first-type light-emitting units, and the second polarization conversion lens covers at least a portion of the second-type light-emitting units; and
the first polarization conversion lens and the second polarization conversion lens are both disposed on a light-output side of the same laser device and are offset from a light-output side of another laser device; or, the first polarization conversion lens covers at least one row of first-type light-emitting units in one laser device, and the second polarization conversion lens covers at least one row of second-type light-emitting units in another laser device.

16. The laser projection device according to claim 14, wherein the light source system further comprises two prism assemblies; wherein
the two prism assemblies are in one-to-one correspondence with the two laser devices, and each of the prism assemblies is disposed between a corresponding laser device and the light-combining lens group, and is configured to adjust laser beams emitted from each row of light-emitting units in the corresponding laser device; and
in laser beams emitted from one row of light-emitting units, a first laser beam emitted from a first light-emitting unit is located on one side of a second laser beam emitted from a second light-emitting unit before being adjusted by a prism assembly, and the first laser beam is located on another side of the second laser beam after being adjusted by the prism assembly, wherein the first light-emitting unit and the second light-emitting unit are light-emitting units respectively disposed on two sides of the row of light-emitting units.

17. The laser projection device according to claim 16, wherein each of the prism assemblies comprises at least two prisms; wherein
each of the at least two prisms covers a corresponding row of light-emitting units, and has a first reflective surface and a second reflective surface arranged oppositely, wherein the first reflective surface is configured to direct the first laser beam emitted by the first light-emitting unit to the second reflective surface, and the second reflective surface is configured to direct the first laser beam reflected by the first reflective surface to the light-combining lens group.

18. The laser projection device according to claim 17, wherein each of the at least two prisms further has a first light-transmitting surface and a second light-transmitting surface arranged oppositely, wherein the first light-transmitting surface and the second light-transmitting surface are both parallel to a light-output surface of a corresponding laser device, the first light-transmitting surface is closer to the corresponding laser device than the second light-transmitting surface, and the first light-transmitting surface covers each light-emitting unit in the corresponding row of light-emitting units; and
the first laser beam emitted by the first light-emitting unit in the one row of light-emitting units sequentially passes through the first light-transmitting surface, the first reflective surface, the second reflective surface, and the second light-transmitting surface before being directed toward the light-combining lens group, and the laser beam emitted by each light-emitting unit other than the first light-emitting unit in the one row of light-emitting units sequentially passes through the first light-transmitting surface and the second light-transmitting surface before being directed toward the light-combining lens group.

19. The laser projection device according to claim 17, wherein the first light-transmitting surface of each of the at least two prisms covers a portion of light-emitting units in the corresponding row of light-emitting units and is offset from another portion of light-emitting units in the corresponding row of light-emitting units; and
laser beams emitted by the light-emitting units covered by the first light-transmitting surface in the one row of light-emitting units sequentially pass through the first light-transmitting surface, the first reflective surface, the second reflective surface, and the second light-transmitting surface before being directed toward the light-combining lens group, and laser beams emitted by the light-emitting units not covered by the first light-transmitting surface in the one row of light-emitting units sequentially pass through the second reflective surface and the second light-transmitting surface before being directed toward the light-combining lens group.

20. The laser projection device according to claim 17, wherein the light source system further comprises a cylindrical lens; wherein
the cylindrical lens is disposed between one of the prism assemblies and the light-combining lens group and covers a second light-transmitting surface of each prism in the prism assembly.
